(19) United States
(12) Patent Application Publication
(10) Pub. No.: US 2026/0146492 A1
(43) Pub. Date: May 28, 2026

(54) PRE-DEFORMING SUPPORT STRUCTURE WORKPIECES FOR SUPPORT STRUCTURES OF VACUUM INSULATING GLASS UNITS

(71) Applicant: VKR Holding A/S, Hørsholm (DK)

(72) Inventors: Simon Johnsen, Hørsholm (DK); Annette Johncock Krisko, Hørsholm (DK); Henrik Aslak Jensen, Hørsholm (DK)

(21) Appl. No.: 19/122,831

(22) PCT Filed: Oct. 6, 2023
(86) PCT No.: PCT/EP2023/077719

§ 371 Date: Apr. 21, 2025

(30) Foreign Application Priority Data
Oct. 19, 2022 (EP) 22202420.0
Oct. 19, 2022 (EP) 22202423.4
Oct. 19, 2022 (EP) 22202427.5
Oct. 19, 2022 (EP) 22202431.7
Feb. 27, 2023 (EP) 23158700.7

(51) Int. Cl. E06B 3/673; E06B 3/66; E06B 3/663; E06B 3/677

(52) U.S. Cl. CPC E06B 3/67326; E06B 3/6612; E06B 3/66304; E06B 3/6775

(57) ABSTRACT

The present disclosure relates to a method of producing a vacuum insulated glass (VIG) unit (1), wherein said method comprises: providing a plurality of support structures (5) comprising contact surfaces (5a, 5b), distributing the provided support structures (5) at a first glass sheet (3) so that one of said contact surfaces (5a, 5b) supports on a first major surface (3a) of the first glass sheet (3), arranging a second glass sheet (4) so that the distributed support structures (5) are placed in a gap (6) between the first major surface (3a) and a second major surface (4a) of the second glass sheet (4), providing an edge seal (7) arranged around the periphery of the glass sheets (3, 4), and evacuating and sealing said gap (6). The providing of the plurality of support structures comprises the steps of feeding support structure workpieces (10) to a deformation unit (20), and shaping support structures (5) by deforming the fed support structure workpieces (10) by means of the deformation unit (20) so as to provide support structures (5) comprising said contact surfaces (5a, 5b).

The present disclosure relates to a method of producing a vacuum insulated glass units, to use of support structures in an evacuated gap of a vacuum insulated glass unit, and to a vacuum insulated glass unit.

### BACKGROUND

Vacuum insulating glass (VIG) units provides several advantages. For example, VIG units may provide superior heat insulation properties when compared to weight and material use of the unit. In order to provide a sufficiently low pressure in an evacuated gap of the VIG unit, a pump evacuates the gap before sealing the gap. To prevent the glass sheets enclosing the evacuated gap from touching during and after gap evacuation, support structures, also known as pillars or spacers, are distributed in the evacuated gap, often in a predefined pattern.

U.S. Pat. No. 10,533,366 B1 and JP2019060085 discloses compressible support structures. These may however provide complex and/or cost expensive solutions. U.S. Pat. No. 6,689,241 B1 discloses rolling support structures over a glass sheet surface so as to adhere at adhesive spots of the glass sheet surface. This may e.g. provide a complex or in other ways undesirable manufacturing solution. CN101481206 discloses a sphere pillar with a solder glass coating. This may e.g. provide a cost expensive and/or complex solution.

The present disclosure provides a solution that may solve or reduce one or more of the above mentioned issues. Additionally or alternatively, the present disclosure may provide a solution that may result in a cost efficient VIG unit and/or be advantageous with regards to large scale manufacturing of VIG units.

### SUMMARY

The present disclosure relates, in a first aspect, to a method of producing a vacuum insulated glass unit. The method comprises providing a plurality of support structures comprising contact surfaces, and distributing the provided support structures at a first glass sheet so that one of the contact surfaces supports on a first major surface of the first glass sheet. A second glass sheet is arranged so that the distributed support structures are placed in a gap between the first major surface and a second major surface of the second glass sheet. An edge seal is arranged around the periphery of the glass sheets, and the gap is evacuated and sealed. The said providing of the plurality of support structures comprises the steps of feeding support structure workpieces to a deformation unit, and shaping support structures by deforming the fed support structure workpieces by means of the deformation unit so as to provide support structures comprising said contact surfaces.

It has shown to be possible to produce vacuum insulating glass (VIG) units providing superior heat insulating properties, even with one evacuated gap. This may provide space saving and/or less heavy and/or less material demanding insulated glass units that are transparent to at least visible light and that have good heat insulating properties. Such may be used for e.g. building windows, doors, cooling or heating furniture such as refrigerators or ovens and/or the like. However, present VIG unit solutions may suffer from the problem of needing cost expensive solutions and parts that in the end may make the VIG units produced unfit for conventional use in conventional building windows, doors, cooling or heating furniture simply due to the high manufacturing costs. One square meter VIG often contains 500-3000 discretely distributed support structures which are small and sometimes called micro spacers because the size is comparable to sand grains.

The present inventor has acknowledged that many support structure solutions presently available to be placed in the in the evacuated gap may provide a substantial contribution to the final cost of the VIG unit so that the VIG unit price increases significantly. The present inventor has found that the pre-deformation of workpieces into support structures before placing the support structures may help to reduce the final VIG unit manufacturing costs.

It is understood that in some embodiments of the present disclosure, said providing of the plurality of support structures may comprise that the support structures may be pre-deformed by the deformation unit at a location that is located away from the VIG unit manufacturing line, and my then be subsequently dispensed at the lass sheet surface by means of e.g. a support structure dispenser at a support structure placement station. This may e.g. help to provide a cost efficient solution.

In other embodiments of the present disclosure, the support structure workpieces may be deformed by the deformation unit during the VIG unit assembly manufacturing.

The present inventor has found that some support structure solutions in some situations may provide issues during the VIG unit manufacturing, as such support structures may clog/disturb or in other ways interfere with automated VIG unit production solutions where support structures are automatically provided and placed on a glass sheet surface by automation equipment. The present inventor has found that deforming support structure workpieces during the VIG unit assembly manufacturing, such as prior to arranging the support structures at the glass sheet surface, this may help to enable use of advantageous, more reliable and/or cost efficient support structure supply/feeding solutions during the VIG unit manufacturing. Hereby efficient and reliable supply and handling of the support structures may be realized. Deforming support structure workpieces during the VIG unit manufacturing prior to arranging the support structures at the glass sheet surface may additionally or alternatively provide that reduced demands to the size, volume, tolerances and/or shape of the support structure workpieces which may e.g. help to improve reliability and/or cost efficiency.

In one or more embodiments of the present disclosure, the support structure workpieces comprises or consist of substantially spherical balls. This may e.g. provide a cost efficient solution and/or a solution where the deformation may be more easy to provide due to e.g. the workpiece geometry.

The substantially spherical balls may in further embodiments of the present disclosure be spherical, solid metal balls, such as solid, spherical steel balls. This may e.g. help to provide a structurally strong and/or cost efficient solution.

It has come to the inventor's attention that spherical balls, such as solid spherical balls, such as solid steel balls are available “off the shelf” which are precisely manufactured and hence may serve as candidates for use as the support structure workpieces that are to be deformed into support structures for VIG units. Such balls are also known as “precision balls”.

Cost efficient precision balls are available on the market with a nominal diameter less than 1 mm, such as less than 600 μm, and even around 400 μm or lower nominal diameter.

At the same time, such precision balls may have good/tight tolerances, for example defined by ISO 3290 relating to features of finished steel balls for roller bearings, and defining different grades of ball bearings.

In embodiments of the present disclosure, tolerances such as ball diameter variations lower than 1 μm, (According to some manufacturers corresponding to “Grade G40”) such as lower than 0.4 μm, (According to some manufacturers corresponding to “Grade G16”) may be used as the support structure workpieces.

In other embodiments of the present disclosure, as the balls will be pre-deformed prior to being used in a VIG unit, higher grade (and hence often more cost efficient but with higher ball diameter/diametrical variations) balls with larger overall diameter variations/lower tolerance than mentioned above may be used, as the deformation may adapt each support structure to the desired height.

In one or more embodiments of the present disclosure, the feeding of the spherical balls may be provided by means of guiding the workpieces, such as spherical balls, from a storage to the deformation unit. Said guiding may in further embodiments of the present disclosure comprise one or more of one or more of pushing, sucking, rolling and/or displacing by means of gravity the spherical balls.

The inventor has found that steel balls are advantageous during the VIG unit manufacturing process until the moment they are placed at the glass sheet, as these balls may have a tendency to reduce the risk of clogging outlets, supply pipes and/or the like. Hence, the risk of manufacturing VIG units missing one or more support structures, and/or the risk of needing to put the manufacturing on hold, may be reduced. However, placing spherically shaped support structures at the glass surface may be more demanding and from a manufacturing perspective, less desired, as it may require e.g. magnets, adhesives or the like to keep the balls in place.

However, plastically deforming the balls by means of the deformation unit assures that balls may be supplied at the manufacturing site near or at a pillar/support structure placement station, and e.g. substantially just before placing the balls at the glass sheet, they may be deformed into a shape providing at least one contact surface that may rest on the glass sheet surface and thereby reduce the risk of the support structure subsequently rolling away.

In one or more embodiments of the present disclosure, the material of the workpieces, such as solid, spherical balls, has a Youngs modulus between 170 Gpa and 280 GPA, such as between 180 GPa and 230 GPa at 20° C.

In one or more embodiments of the present disclosure, the material of the support structures such as the solid, spherical balls may have a yield stress of less than 600 MPa, such as less than 530 MPa, for example less than 480 MPa at 20° C.

In one or more embodiments of the present disclosure, the feeding of the support structure workpieces to the deformation unit may comprise separating, such as cutting, support structure workpieces from source material such as a filament or wire.

This may provide a cost efficient solution that may also provide a reliable support structure material supply. A drive may hence in further embodiments of the present disclosure be controlled to supply a predefined amount of support structure material that may then be cut therefrom, and this may hence provide the support structure workpiece.

For example, a roller pair may be controlled to supply a filament or wire consisting of or comprising the support structure material towards a cutter, and the cutter may then be operated to cut the filament or wire into workpieces to be deformed and thereby adapted to the desired shape and/or height.

This cutting from a source material may in embodiments of the present disclosure be provided at a VIG unit assembly manufacturing line.

In one or more embodiments of the present disclosure, the structure of the support structure workpieces is a solid structure, such as a monolithic, solid structure.

Using solid support structure workpieces may help to provide a cost efficient solution. It may also provide a stronger support structure after the deformation. One or more surface coatings may be present at the workpiece in embodiments of the present disclosure. In other embodiments, surface coatings may be omitted.

In one or more embodiments of the present disclosure, said support structures are mutually un-connected at the glass sheet surface. This may e.g. enable a more easy and/or individual VIG unit manufacturing. It may additionally or alternatively hep to provide a stronger product.

In one or more embodiments of the present disclosure, said distributing of the provided support structures may comprise distributing the support structures by means of a support structure dispenser. This may e.g. help to enable providing a stronger VIG unit compared to e.g. some other prior art solutions, and/or may help to provide an adaptable and/or cost efficient solution.

In one or more embodiments of the present disclosure, said dispenser may dispenses the support structures from a support structure storage.

In one or more embodiments of the present disclosure, the dispenser may comprise the support structure storage. This may e.g. comprise a space saving and/or more mechanically simple solution.

In one or more embodiments of the present disclosure, the support structure storage comprises a plurality of support structures. This may e.g. comprise a space saving and/or faster solution.

In one or more embodiments of the present disclosure, said distributing of the provided support structures may comprise dispensing, such as dropping, the support structures individually at the first major surface. This may e.g. provide a solution that may help to provide a VIG unit if improved structural integrity and/or a solution that may be easily adaptable and/or faster.

In one or more embodiments of the present disclosure, a support structure retainer may retain the respective support structure until it is desired to be dispensed/dropped towards the surface.

In one or more embodiments of the present disclosure, an actuator, such as a linear actuator or a motor, is controlled so as to dispense the support structures. This may e.g. provide a reliable dispensing solution.

In one or more embodiments of the present disclosure, the support structures may be placed in a support structure storage, such as an intermediate support structure storage, comprising a plurality of the support structures, and wherein a dispenser dispenses support structures from the support structure storage, such as individually, towards the glass sheet surface.

In one or more embodiments of the present disclosure, the deformation of the support structure workpieces by means of the deformation unit provides support structures comprising two oppositely directed, such as substantially parallel, contact surfaces at each support structure.

This provides a simple solution where desired contact surfaces and/or contact surface areas are provided. The contact surfaces may be configured so that the first contact surfaces abut the major surface of the first glass sheet, and the second contact surface abut a major surface of the second glass sheet.

It is understood that the workpiece in embodiments of the present disclosure may comprise one or more initial, predefined, flat such as substantially plane, surfaces that maybe enlarged by the deformation unit during the workpiece deformation into said contact surfaces to act as contact surfaces in the VIG unit for contacting major surfaces of the glass sheets that faces the gap. In other embodiments, e.g. where spherical balls are used as workpieces, such an initial predefined surfaces may not be present at the workpiece.

In some embodiments the contact surfaces area after workpiece deformation may make up 50% or more of the support structure silhouette when seen perpendicular to the contact surface.

In some embodiments the contact surfaces area makes up 95% or less, such as 85% or less or 75% or less of the support structure silhouette when seen perpendicular to the contact surface.

In some embodiments of the present disclosure, the deformation of the support structure workpieces by the deformation unit provides at least one plane contact surface.

A plane contact surface may be advantageous in order to reduce local stress on the glass sheet and hence reduce the amount and/or size of cracks in the glass sheets at the location of the support structures.

In one or more embodiments of the present disclosure, the support structure workpieces may be made from, such as consist of a metal such as steel. This may be a strong material and yet cost efficient that may also be suitable for a plastic deformation. The support structure workpieces may in other embodiments be made from, such as consist of, a metal such as nickel (Ni). In one or more embodiments of the present disclosure, the support structure workpieces may be made from, such as consist of a polymer.

In one or more embodiments of the present disclosure, the support structures may be plastically deformed by the deformation unit to have a first support structure height. The first support structure height may in further embodiments be a predetermined first support structure height. The first support structure height may be less than an initial maximum height of the workpiece.

In some embodiments of the present disclosure, said plastic deformation of the support structure workpieces may be obtained by coining. This may e.g. provide a cost efficient and/or mechanically simple solution.

In one or more embodiments of the present disclosure, the deformation of the support structure workpieces by the deformation unit may provide an at least 5% reduction of the initial maximum height of the support structure workpieces into a first support structure height. In embodiments of the present disclosure, the deformation of the support structure workpieces by the deformation unit may provide an at least 20%, such as an at least 40% reduction of the initial maximum height of the support structure workpieces.

The provided reduction of the initial maximum height of the respective support structure workpiece by the deformation unit results in a plastic deformation of the support structure workpieces into a support structure with a desired support structure height.

In one or more embodiments of the present disclosure, a further, second deformation of one or more support structures having the first support structure height due to the deformation provided by means of the deformation unit is provided by means of the major surfaces of the glass sheets facing the gap.

In some embodiments of the present disclosure, the further deformation by means of the major surfaces of the glass sheets may be obtained by means of an evacuation pump for evacuating the gap. This induces a compression force onto the support structures by means of the glass sheet surfaces when the gap is evacuated while the VIG unit assembly is in a surrounding pressure such as atmospheric pressure.

Additionally or alternatively, an external mechanical pressing arrangement, such as comprising pressing bodies such as pressing plates and one or more actuators, may provide some of the further, second deformation or most, such as all of the further, second deformation. A hardware controller may control the actuator(s).

In some embodiments, the further, second deformation may be provided partly by means of an evacuation pump evacuating the gap, and an external mechanical pressing arrangement. This may provide an individual adaption of the support structure to the VIG unit. For example, tempered glass sheets such as thermally tempered may be uneven due to e.g. roller waves or other surface variations resulting from the manufacturing of the tempered glass sheets. By allowing a deformation of the support structures by means of the major glass sheet surfaces facing the gap during VIG unit production, this may help to provide individual adaption of the support structure height to the individual glass sheet surface unevenness.

The provided further, second deformation may in embodiments of the present disclosure be a plastic deformation of the support structure.

In one or more embodiments of the present disclosure, the further, second deformation provides an at least 10%, such as an at least 20%, for example an at least 30% reduction of the first height of each support structure of a group, such as a subgroup, of the support structures placed in the gap. This may be a plastic deformation.

In one or more embodiments of the present disclosure, the further, second deformation of the support structure height provided by means of the pump when the gap is evacuated may provide a deformation between 20% and 70%, such as between 30% and 70%, for example between 40% and 60% reduction of the first height of a group, such as a subgroup, of the support structures placed in the gap.

In one or more embodiments of the present disclosure, the overall deformation provided by means of the deformation unit and by means the further, second deformation of the first support structure height provides/results in that each support structure of a group, such as a subgroup, of the support structures placed in the evacuated gap has a height that is least 20% smaller, such as at least 30% smaller, for example at least 40% smaller than the initial maximum height of the respective workpiece.

This may e.g. provide an advantageous adaption of the initial workpiece into a support structure that has adapted to the individual glass sheet surface(s).

In one or more embodiments of the present disclosure, at least 5%, such as at least 10%, such as at least 25% of the total amount of support structures of the vacuum insulated glass unit assembly may be subjected to said further, second deformation, such as a plastic deformation, such as by means of an evacuation pump and/or external mechanical pressing arrangement.

In one or more embodiments of the present disclosure, between 5% and 95%, such as between 15% and 80%, for example between 20% and 60% of the total amount of support structures of the VIG unit assembly may be subjected to said further deformation by means of the pump.

The further deformation by means of the pump may in embodiments of the present disclosure comprise a plastic and/or elastic deformation.

In one or more embodiments of the present disclosure, the first and/or second glass sheet(s) may be tempered glass sheets such as thermally tempered glass sheets.

The first and/or second glass sheets may in in embodiments of the present disclosure be tempered glass sheets, such as thermally tempered or chemically tempered glass sheets. Thermally tempered glass sheets may be advantageous these may be considered cost efficient and also provides a significant increase in the strength of the glass sheet when compared to using annealed glass sheets. This may hence allow for e.g. lower pressure in the gap and/or larger distance between the support structures. Thermally tempered glass sheets may however suffer from so called roller waves that introduces uneven major surfaces at the thermally tempered glass sheets and/or suffer from other out of flatness issues such as warping, bowing and/or the like.

In one or more embodiments of the present disclosure, said deformation unit may be arranged at a deformation station of a vacuum insulated glass unit assembly manufacturing/production line. The deformation station provides the support structure workpiece deformation during vacuum insulated glass unit assembly manufacturing.

The inventor has found that this may provide an advantageous and more reliable VIG unit assembly manufacturing. For example, the designer(s) of the insulated glass unit assembly manufacturing line are hence not necessarily bound to a predefined shape and/or size and/or tolerance of the support structures as the final support structure design is determined/provided at the VIG unit assembly manufacturing line. Additionally or alternatively, it may help to allow use of a more cost efficient support structure solutions.

In one or more embodiments of the present disclosure, the deformation of the support structure workpieces by the deformation unit may be provided at an assembly line for providing Vacuum Insulated Glass unit assemblies comprising the first and second glass sheets and the distributed support structures placed in the gap.

In one or more embodiments of the present disclosure, the deformation unit may be arranged at a deformation station of a vacuum insulated glass unit assembly production/manufacturing line, wherein the deformation unit provides the support structure workpiece deformation to provide support structures to be placed at a first glass sheet while the first glass sheet is arranged at the vacuum insulated glass unit assembly production/manufacturing line.

In one or more embodiments of the present disclosure, support structures are placed at the first glass sheet surface of the first glass sheet by a support structure placement arrangement of a support structure placement station in a vacuum insulated glass unit assembly production/manufacturing line. The deformation unit may in embodiments provide the support structure workpiece deformation to produce support structures to be placed at a first glass sheet after said first glass sheet has been arranged at a support structure placement station.

In one or more embodiments of the present disclosure, the deformation unit provides the support structure work workpiece deformation to produce support structures to be placed at a first glass sheet while the first glass sheet moves through or into a support structure placement station.

In one or more embodiments of the present disclosure, the deformation of the support structure workpieces is provided by consecutively feeding and deforming, such as coining, the support structure workpieces in a continuous feeding and deformation process, preferably during vacuum insulated glass unit assembly manufacturing at a vacuum insulated glass unit assembly manufacturing line.

This may provide an efficient manufacturing.

In one or more embodiments of the present disclosure, said support structures may be mutually un-connected. Hence, e.g. a filament, wire or the like that interconnects the support structures may be omitted. The support structures may e.g. comprise individual support structures that are individually placed, e.g. by means the same support structure dispenser or different support structure dispensers.

This may e.g. provide advantages during manufacturing and/or provide a more desirable VIG unit as the filament is not present. It may additionally or alternatively help to provide a more resistant VIG unit.

In one or more embodiments of the present disclosure, the deformation of the support structure workpieces may be provided by a “cold coining” or “cold forging” process where the support structure workpieces are kept below a predefined temperature, such as below 100° C., such as below 50° C., for example below 40° C. during the deformation process, and are thus not heated to a predefined higher softening temperature by a heater.

The deformation unit may in embodiments of the present disclosure provide the support structure workpiece deformation during vacuum insulated glass unit assembly manufacturing in a “continuous” batch process where a plurality of workpieces are deformed at the same time by a deformation unit, or in a continuous process where the workpieces are deformed consecutively one by one.

In one or more embodiments of the present disclosure, the deformation unit comprises a press such as a mould, such as a press mould.

This may e.g. comprise a cost efficient and/or mechanically simple manufacturing solution.

The press may in embodiments of the present disclosure comprise a motor actuated press, a gear driven press, a mechanical press, a roller press or a hydraulically actuated press.

The press may in embodiments of the present disclosure be configured to coin the support structure workpieces.

In one or more embodiments of the present disclosure, the deformation of the support structure workpieces may be provided by means of a coining or forging process, such as by means of pressing, such as hammering/punching.

In one or more embodiments of the present disclosure, the material of the support structure workpiece, prior to deformation by the deformation unit, may extend continuously between pressing surfaces of pressing bodies of the deformation unit.

Hence, no “artificial” pre-shaped cavities may be provided internally in the support structure workpiece between the pressing surfaces of the pressing bodies.

In one or more embodiments of the present disclosure, the outer surface of the respective support structure is made from the same material as the material providing the structural integrity of the support structures. This may e.g. provide a cost efficient solution.

In one or more embodiments of the present disclosure, each support structure consist of one material such as a polymer or metal alloy, such as steel.

In one or more embodiments of the present disclosure, the deformation unit comprises a roller press.

In one or more embodiments of the present disclosure, the weight and/or volume of the respective support structure placed at the first glass sheet substantially corresponds to the weight and/or volume of the support structure workpiece used for the support structure before the deformation by means of the deformation unit. This may provide a solution where individual workpieces are used for shaping support structures and provides the material for the final support structure.

In one or more embodiments of the present disclosure, said support structures have a first height that is less than 0.4 mm, such as less than 0.3 mm, for example around or less than 0.2 mm as a result of the deformation by the deformation unit.

In one or more embodiments of the present disclosure, the feeding of the support structure workpieces to the deformation unit is provided by means of a feeding device feeding the support structure workpieces from a support structure workpiece material storage.

In one or more embodiments of the present disclosure, the feeding device (40) comprises a workpiece (10) dosing system (34, 35), such as comprising one or more of
a workpiece material (31) cutter (35),
A supply pipe or tube (36) and/or a slideway (38)
one or more pushing and/or pulling rolls (33)
a removable blocking (34), or
one or more magnets.

In one or more embodiments of the present disclosure, the workpiece is maintained in position during and/or prior to deformation at the deformation unit, such as at a support, by means of one or more of a magnet, one or more side walls and/or a liquid, such as glycerine.

In one or more embodiments of the present disclosure, the maximum width W1 of the support structure after the workpiece deformation is larger, such as at least 3% larger, for example 20 % larger, for example at least 30% larger, or at least 100% larger than the initial width of the workpiece before the workpiece deformation.

In one or more embodiments of the present disclosure, the maximum width of the support structure after the workpiece deformation by the deformation unit is at least 20% larger, such as at least 40% larger, for example at least 50% larger, than the initial width of the workpiece before the workpiece deformation.

For example, in one or more embodiments of the present disclosure, the maximum width of the support structure after the workpiece deformation by the deformation unit may be between 3% and 120%, such as between 5% and 85%, for example between 20% and 65% larger than the initial width of the workpiece before the workpiece deformation.

The present disclosure moreover, in a second aspect, relates to a method of producing support structures for use in an evacuated gap of vacuum insulated glass units. This method comprises the steps of
feeding support structure workpieces to a deformation unit, and
shaping support structures by deforming the fed support structure workpieces by means of the deformation unit so as to provide support structures comprising contact surfaces.

In one or more embodiments of the second aspect, said deformation is provided prior to arranging the support structures at a glass sheet surface for the vacuum insulated glass unit. In one or more embodiments of the second aspect, said deformation is provided by means of a press prior to arranging the support structures at a glass sheet surface for the vacuum insulated glass unit.

In one or more embodiments of the second aspect, the support structure workpieces comprises or consist of substantially spherical balls.

In one or more embodiments of the second aspect, the support structure workpieces comprises or consist of substantially spherical solid metal balls, such as solid, spherical steel balls.

In one or more embodiments of the second aspect, said workpieces are solid structures.

In further embodiments of the second aspect, said deformation by means of the deformation unit may be provided at a vacuum insulated glass unit assembly manufacturing line prior to arranging the support structures at a glass sheet surface.

In one or more embodiments of the second aspect, the deformation unit provides the support structure workpiece deformation to provide support structures to be placed at a first glass sheet while the first glass sheet is arranged at the vacuum insulated glass unit assembly manufacturing line.

In one or more embodiments of the second aspect, the deformation unit provides the support structure workpiece deformation after a first glass sheet comprising a major surface for receiving and supporting the support structures has been arranged at a support structure placement station of the vacuum insulated glass unit assembly manufacturing line.

In one or more embodiments of the second aspect, the deformation unit provides the support structure work workpiece deformation to provide support structures to be placed at a first glass sheet comprising a major surface for receiving the support structures while the first glass sheet moves through or into a support structure placement station of the vacuum insulated glass unit assembly manufacturing line.

In one or more embodiments of the present disclosure, a plurality of said plastically deformed support structures comprises a first convex side surface and a second opposite, convex side surface when seen in a cross section of the plastically deformed support structure. The said convex side surfaces extends between the major glass sheet surfaces, wherein the convex side surfaces each describes minor, circular arcs having non-coinciding centres, such as a result of plastic workpiece deformation by means of the deformation unit.

It may be so that at least 80%, such as at least 90%, for example at least 95% of the length of each minor circular arc is coinciding with the circle periphery of the respective circle.

The present disclosure additionally relates, in a third aspect, to use of support structures in an evacuated gap of a vacuum insulated glass unit, wherein said support structures are provided by deforming, such as plastically deforming, support structure workpieces, such as spherical balls, to have a predefined height by means of a deformation unit prior to arranging the support structures at a surface of a glass sheet for the vacuum insulated glass unit.

In one or more embodiments of the third aspect, said deformation unit comprises a press.

In one or more embodiments of the third aspect, the support structure workpieces comprises or consist of substantially spherical solid metal balls, such as solid, spherical steel balls.

In one or more embodiments of the third aspect, the structure of the support structure workpieces is a solid structure, such as a monolithic, solid structure.

In one or more embodiments of the third aspect, the support structures are used in a method of producing a vacuum insulated glass (VIG) unit according to one or more of the embodiments described previously and/or below.

In one or more embodiments of the third aspect, the deformation of the support structure workpieces is provided during vacuum insulated glass unit assembly manufacturing at a deformation station of a vacuum insulated glass unit assembly manufacturing line.

In other embodiments of the third aspect, the deformation of the support structures may be provided by the deformation unit at a location that is located away from a vacuum insulated glass unit assembly manufacturing line, and may then be subsequently dispensed at the glass sheet surface from a support structure storage by means of e.g. a support structure dispenser at a support structure placement station. This may e.g. help to provide a cost efficient solution.

In one or more embodiments of the third aspect, the deformation of the support structure workpieces (by the deformation unit provides an at least 5% reduction of the initial maximum height of the support structure workpieces into a first support structure height (H1), such as a predefined first support structure height.

In one or more embodiments of the third aspect, the deformation of the support structure workpieces by the deformation unit may provide an at least 20%, such as an at least 40%, reduction of the initial maximum height of the support structure workpieces into a first support structure height, such as a predefined first support structure height.

In one or more embodiments of the third aspect, said balls may have a diameter of less than 0.6 mm, such as less than 0.5 mm, for example less than 0.4 mm.

In one or more embodiments of the third aspect, said balls may have a diameter between 0.25 mm and 1.5 mm, such as between 0.25 mm and 1 mm, such as between 0.28 mm and 0.42 mm.

The present disclosure additionally relates, in a fourth aspect, to a vacuum insulated glass unit comprising a first glass sheet and a second glass sheet, and an edge seal arranged around the periphery of the tempered glass sheets. The vacuum insulated glass unit comprises an evacuated gap arranged between major surfaces of said first and second glass sheets and the evacuated gap is enclosed by the edge seal. The vacuum insulated glass unit according to the fourth aspect may in further embodiments of the present disclosure be a vacuum insulated glass unit produced by means of a method according to one or more of the above mentioned embodiments and/or aspects.

The vacuum insulated glass unit may in embodiments of the present disclosure be placed in a building window such as a façade window or a roof window.

The present disclosure additionally relates, in a fifth aspect, to use of a deformation unit, such as a press, wherein the deformation unit is used for shaping support structures by deforming support structure workpieces so as to provide support structures comprising contact surfaces, wherein said deformation unit deforms the support structure workpieces prior to arranging the support structures shaped by the deformation unit at a major surface of a glass sheet for a vacuum insulated glass unit.

In further embodiments of the fifth aspect, the support structures may be plastically deformed by coining by the deformation unit so as to have a first support structure height, such as a predetermined first support structure height, that is less than an initial maximum height of the workpiece.

In some embodiments of the fifth aspect, the deformation by means of the deformation unit may be provided in a vacuum insulated glass unit assembly manufacturing line.

In one or more embodiments of the fifth aspect, the deformation unit is used in a method according to any of the preceding embodiments.

In one or more embodiments of the fifth aspect, the use of the deformation unit according to one or more embodiments of the fifth aspect is provided so as to provide support structures for use according to e.g. one or more of the embodiments according to the third aspect.

The present disclosure additionally relates, in a sixth aspect, to a method of shaping support structures for a vacuum insulated glass unit, wherein said method comprises
providing support structure work pieces to a deformation unit, and
shaping support structures by deforming the provided support structure workpieces by means of a deformation unit,
   wherein said deformation of the support structure workpieces by means of the deformation unit is provided prior to arranging the support structures at a major surface of a glass sheet for a vacuum insulated glass unit.

In one or more embodiments of the sixth aspect, the support structure workpieces comprises or consist of substantially spherical balls.

In one or more embodiments of the sixth aspect, the support structure workpieces comprises or consist of substantially spherical solid metal balls, such as solid, spherical steel balls.

In one or more embodiments of the sixth aspect, the structure of the support structure workpieces is a solid structure, such as a monolithic, solid structure.

In one or more embodiments of the sixth aspect, the support structure workpieces are made from, such as consist of, a metal such as steel.

In one or more embodiments of the sixth aspect, the support structure workpieces are plastically deformed by the deformation unit so as to have a predetermined first support structure height, that is less than an initial maximum height of the workpiece, and wherein the height extends between contact surfaces, of the support structures.

In one or more embodiments of the sixth aspect, the contact surfaces may be provided and/or shaped by the deformation unit.

In one or more embodiments of the sixth aspect, the deformation unit comprises a press such as a mould, such as a press mould and/or a roller press.

In one or more embodiments of the sixth aspect, the deformation comprises a coining operation.

In one or more embodiments of the sixth aspect, the weight and/or volume of the respective support structure substantially corresponds to the weight and/or volume of the support structure workpiece used for the support structure before the deformation by means of the deformation unit.

It is generally understood that in one or more embodiments of the present disclosure, such as according to the first, second, third, fourth fifth and/or sixth aspect, said support structures may have a first height that is less than 0.4 mm, such as less than 0.3 mm, for example around or less than 0.2 mm as a result of the deformation by the deformation unit.

It is generally understood that the method(s) may not be limited to a particular step order or sequence unless explicitly stated. For example providing the edge seal does not need to be performed in a particular step or sequence. One or more edge seals may be provided before or after the support structures.

### FIGURES

Aspects of the present disclosure will be described in the following with reference to the figures in which:

FIGS. 1a-1c: illustrates schematically producing support structures for use in an evacuated gap of vacuum insulated glass units according to embodiments of the present disclosure,

FIG. 2: illustrates a glass sheet with support structures placed thereon, according to embodiments of the present disclosure,

FIG. 3: illustrates evacuation of a vacuum insulated glass unit assembly according to embodiments of the present disclosure,

FIG. 4: illustrates a vacuum insulated glass unit according to embodiments of the present disclosure,

FIG. 5a-5b: illustrates support structure workpieces being separated from a source material such as a wire or filament and then deformed by a deformation unit, according to embodiments of the present disclosure,

FIG. 5c: illustrates deformation of a workpiece that has been separated from a source material to provide a support structure,

FIG. 5d: illustrates a support structure according to embodiments of the present disclosure,

FIG. 6a-6c: illustrates a plurality of support structure dispenser outlets arranged in a dispenser array according to embodiments of the present disclosure,

FIG. 7: illustrates a further, second support structure deformation according to embodiments of the present disclosure,

FIG. 7a: illustrates deformation of a workpiece into a support structure/spacer according to embodiments of the present disclosure,

FIG. 8: illustrates a VIG unit with support structures in an evacuated gap of a VIG unit where the support structures have different height,

FIGS. 9a-11: illustrates images of a support structures according to various embodiments of the present disclosure,

FIG. 12a: illustrates a workpiece according to embodiments of the present disclosure,

FIGS. 12b-12e: illustrates the workpiece type of FIG. 12a subjected to different loads and the resulting deformation of the workpiece into a support structure for a VIG unit,

FIG. 13: illustrates a manufacturing line according to various embodiments of the present disclosure,

FIG. 14: illustrates a workpiece having a conical shape in a deformation unit,

FIG. 15: illustrates a plurality of support structures distributed with a distance on a major glass sheet surface, according to embodiments of the present disclosure,

FIG. 16: illustrates a further, second support structure deformation by means of an external mechanical pressing arrangement according to further embodiments of the present disclosure, and

FIG. 17: illustrates dispensing of support structures individually by means of a dispenser, according to embodiments of the present disclosure.

### DETAILED DESCRIPTION

In relation to the figures described below, where the present disclosure may be described with reference to various embodiments, without limiting the same, it is to be understood that the disclosed embodiments are merely illustrative of the present disclosure that may be embodied in various and alternative forms. The figures are not to scale; some features may be exaggerated or minimized to show details of particular components. Therefore, specific structural and functional details disclosed herein are not to be interpreted as limiting, but merely as a representative basis for e.g. teaching one skilled in the art to variously employ the present disclosure.

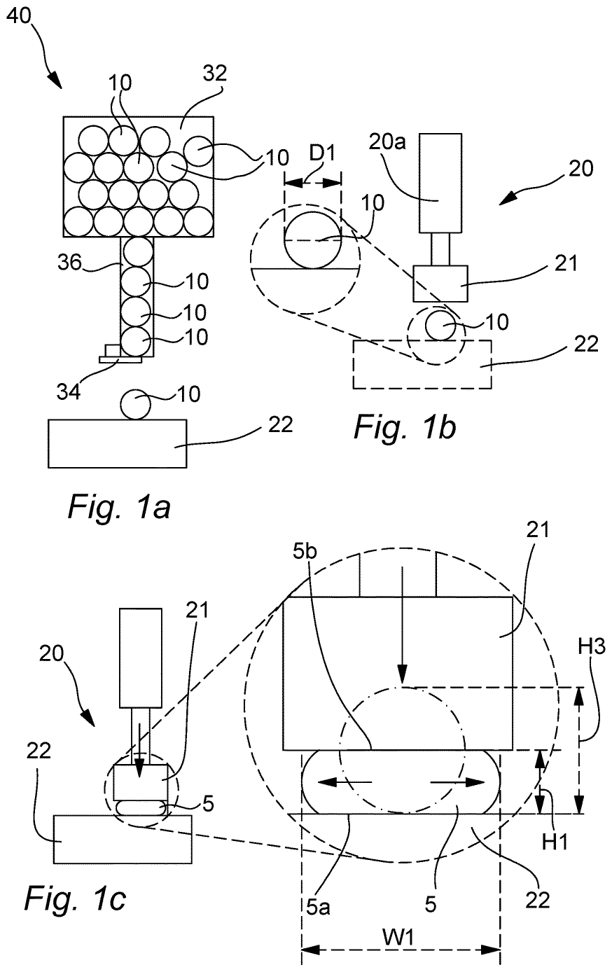

FIGS. 1a-1c illustrates schematically a method of producing support structures 5 for use in an evacuated gap of vacuum insulated glass units 1 according to embodiments of the present disclosure, where workpieces/work pieces 10 are deformed by a deformation unit 20.

In FIG. 1a, a feeder/feeding device 40 supplies workpieces 10 towards a workpiece support 22. The feeding device comprises a workpiece dosing system that may comprise a movable barrier/blocking 34 that may be electrically driven, pneumatically drive and/or the like.

The feeding device 40 comprises a supply pipe or tube 36 containing workpieces 10. When actuating the movable barrier, a workpiece (or more if desired) 10 is/are dispensed from the feeding device towards the support 22. In other embodiments, the dosing system may comprise a magnet for magnetizing and hence dosing one or more workpieces 10 in case the workpieces 10 are made from or comprises a ferromagnetic material. The support structures to be made by the deformation unit 20 may also be called spacers or pillars.

In FIG. 1b, a deformation unit 20 is illustrated. The deformation unit 20 comprises in FIG. 1b a press 21, such as a press mould. An actuator 20a, such as a linear actuator, for example an actuator driven by an electric motor, pneumatics and/or the like moves the press 21 device to shape the workpiece 10 on the support 22. In other embodiments (not illustrated), the deformation unit 20 may comprise a roller press (not illustrated).

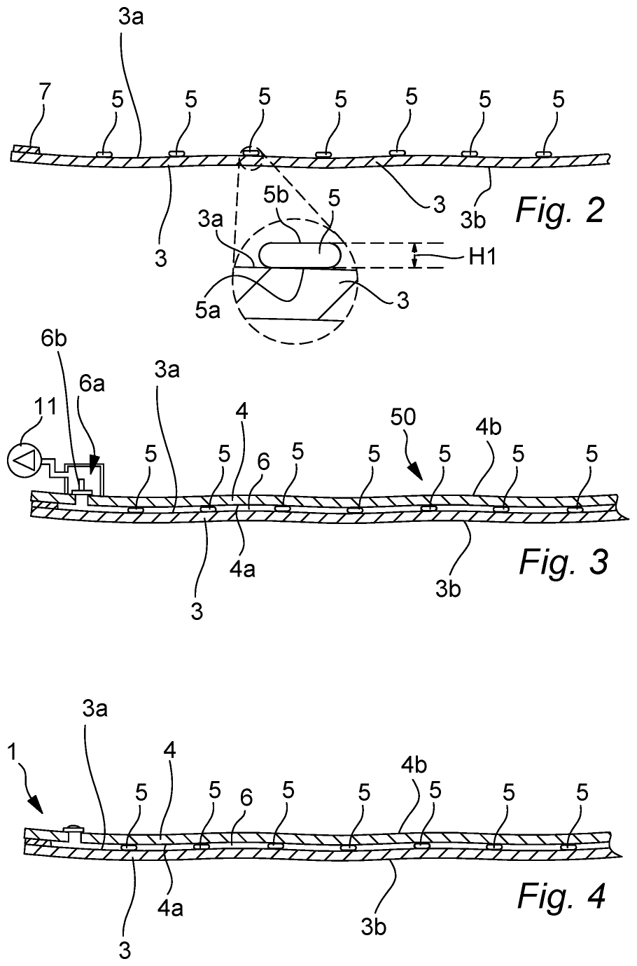

The deformation unit 20 provides a pre-deformation of the work-piece(s) 10 prior to placing the support structure 5 provided by means of/resulting from the work piece deformation at a VIG unit surface 3a (see FIG. 2).

The deformation unit 20 may in embodiments of the present disclosure provide the support structure workpiece 10 deformation during e.g. vacuum insulated glass unit assembly manufacturing in a “continuous” batch process where a plurality of workpieces are deformed at the same time by the deformation unit 20, or in a continuous process where workpieces 10 are deformed consecutively one by one.

As illustrated in FIG. 1c, the deformation of the workpiece 10 by means of the deformation unit 20 shapes support structures 5 by deforming the support structure workpiece 10 fed by the feeding device. This provides a support structure 5 comprising contact surfaces 5a, 5b for contacting opposing glass sheet surfaces 4a, 3a, see FIGS. 2 and 3. The contact surfaces 5a, 5b provided may in embodiments of the present disclosure be flat such as plane, but may also in further embodiments be shaped to have another predetermined/desired surface shape. The deformation of the workpiece 10 hence reduces the initial maximum height H3 of the workpiece 10 to a desired, such as predetermined, height H1. This may be provided by a coining of the workpiece 10 to have the desired workpiece height H1.

The deformation provides that the width W1, such as the diameter, of the shaped support structure 5 becomes larger than the initial width, such as diameter D1, of the workpiece as illustrated in FIG. 1c.

In one or more embodiments of the present disclosure, the deformation of the support structure workpieces 10 by the deformation unit 20 may be provided by a “cold coining” or “cold forging” process where the support structure workpieces are kept below a predefined temperature, such as below 100° C., such as below 50° C., for example below 40° C. during the deformation process, and are thus not heated to a predefined temperature by a heater. In some other embodiments of the present disclosure, the deformation of the support structure workpieces 10 by the deformation unit 20 may be provided by a heating and deforming operation (not illustrated) where the workpieces are heated to a temperature, for example above 100° C., such as above 400° C., for example above 800° C. and then deformed by hammering or pressing.

The support structure workpieces 10 may as illustrated in FIGS. 1a-1c, in embodiments of the present disclosure, be substantially spherical balls such as metal balls, for example steel balls. The balls may be solid. This may provide that the balls are without an internal cavity, such as without a predefined internal cavity. The balls 10 may in embodiments of the present disclosure have a diameter D1 of less than 0.6 mm, such as less than 0.5 mm, for example less than 0.4 mm. In embodiments of the present disclosure, the diameter D1 may be between 0.25 mm and 1.5 mm, such as between 0.25 mm and 1 mm, such as between 0.28 mm and 0.42 mm. In some embodiments, the balls used may be balls having a diameter of 0.30 mm or 0.40 mm. As the workpiece in FIG. 1a-1c is a spherical ball, the initial maximum height H3 of the workpiece 10 corresponds to the ball diameter D1.

The spherical balls 10 may be metal precision balls such as steel precision balls. Such precision balls may have good/tight tolerances, for example defined by ISO 3290 relating to features of finished steel balls for roller bearings, and defining different grades of ball bearings. In embodiments of the present disclosure, tolerances such as ball diameter variations lower than 1 μm, (According to some manufacturers corresponding to “Grade G40”) such as lower than 0.4 μm, (According to some manufacturers corresponding to “Grade G16”) may be used as the support structure workpieces. In other embodiments of the present disclosure, as the balls will be pre-deformed prior to being used in a VIG unit, even higher grade (and hence often more cost efficient but with higher ball diameter/diametrical variations) balls with larger overall diameter variations/lower tolerance than mentioned above may be used, as the deformation may adapt each support structure to the desired height H1.

The spherical balls, such as spherical solid metal balls, such as solid, spherical steel balls may be spherical with a tolerance, such as diametrical tolerances, within ±200 μm, such as within ±100 μm, such as within ±50 μm, for example within ±20 μm.

The spherical balls, such as spherical solid metal balls, such as solid, spherical steel balls may in embodiments of the present disclosure be spherical with a tolerance, such as diametrical tolerances, within ±50 μm, such as within ±5 μm, such as within ±1 μm.

The spherical balls, such as spherical solid metal balls, such as solid, spherical steel balls may in embodiments be spherical balls with a diametrical tolerances that varies more than within ±10 μm, such as more than within +40 μm, such as more than within ±100 μm. The pre-deformation of the balls may provide that the precision requirements to the balls may be less restrictive.

Surface roughness (Ra) tolerance of the used spherical balls may in embodiments of the present disclosure be less than 0.06 μm, such as less than 0.03 μm, for example less than 0.02 μm.

In some embodiments, material of the workpieces 10, such as solid, spherical balls, has a Youngs modulus between 170 GPa and 280 GPa, such as between 180 GPa and 230 GPa at 20° C. In one or more embodiments of the present disclosure, the material of the support structures, such as solid, spherical balls, may have a yield stress of less than 600 MPa, such as less than 530 MPa, for example less than 480 MPa at 20° C.

The feeding of the spherical balls 10 is in FIGS. 1a-1c provided by means of guiding, such as one or more of pushing, sucking, rolling and/or displacing by means of gravity, the spherical balls 10 from a storage 32 to the deformation unit 20 support 22. If pushing or sucking is provided in embodiments of the present disclosure to guide the workpieces, a pump, such as an air pump (not illustrated) may provide the pressure needed for the desired workpiece 10 guiding and/or support structure 5 guiding.

Gravity may help to provide the guiding, e.g. by also the spherical balls rolling towards the support 22. The balls 10 may provide that edges that may cause the workpieces to be stuck in the guiding path are absent, and this may provide a more reliable workpiece supply.

It is generally understood that the structure of the support structure workpieces 10 may in embodiments of the present disclosure be a solid structure, such as a monolithic, solid structure.

As can be seen from FIG. 1c, the deformation of the support structure workpiece 10 by the deformation unit 20 provides/shapes a support structure 5 comprising two oppositely directed, flat, such as substantially parallel, contact surfaces 5a, 5b at each support structure 5.

The contact surfaces 5a, 5b are configured so that one of the first and second contact surfaces 5a, 5b abuts the major surface of the first glass sheet, and the other of the first and second contact surface abuts a major surface of the second glass sheet (see e.g. FIGS. 2-4).

In some embodiments, each contact surface 5a, 5b area may make up 50% or more, such as 75% or more of the support structure silhouette when seen perpendicular to the respective contact surface 5a, 5b. In some embodiments the contact surfaces area of each contact surface 5a, 5b makes up 95% or less, such as 85% or less or 75% or less of the support structure silhouette when seen perpendicular to the contact surface.

In some embodiments the contact surfaces area of each contact surface makes up between 50% and 95%, such as between 60% and 80% of the support structure silhouette when seen perpendicular to the contact surface 5a, 5b.

The weight and/or volume of the respective support structure 5 placed at a glass sheet may substantially corresponds to the weight and/or volume of the support structure workpiece 10 used for the support structure 5 before the deformation by means of the deformation unit 20.

FIG. 2 illustrates schematically a cross sectional view of a first glass sheet 3 according to embodiments of the present disclosure, where a plurality of the support structures 5 are distributed at the first glass sheet 3 so that one of the contact surfaces 5a, 5b of the support structures 5 supports on the major surface 3a of the glass sheet 3.

FIG. 2. illustrates a further embodiment where an edge sealing material, such as a solder glass material, e.g. a glass frit material, a solder metal material or the like is placed at the glass sheet periphery. In other embodiments, dependent on the edge sealing solution for the VIG unit, the edge sealing material 7 may be omitted.

FIG. 3 illustrates schematically a cross sectional view of a VIG unit assembly where a further, second glass sheet 4 has been placed so that the support structures 5 are placed between the first major glass sheet surface 3a facing the gap 6 and a second major surface 4a of the second glass sheet 4 facing the gap 6.

An evacuation pump 11 is connected to a pump out port 6a by means of a suction cup or the like (e.g. as illustrated), and the pump 11 evacuates the gap 6. In other embodiments (not illustrated), the entire VIG unit assembly may be placed in a vacuum chamber, and an evacuation pump may then evacuate the entire vacuum chamber with the VIG unit therein. In some situations, at least the sealing of the gap (after gap evacuation) and possibly also the fusing at the edges by an applied edge seal 7 or by fusing the glass sheets directly may also be obtained in such a vacuum chamber.

FIG. 4 illustrates schematically a cross sectional view of a VIG unit 50 according to embodiments of the present disclosure. The VIG unit 50 comprises the first glass sheet 3a having a first major surface 3a, and a second glass sheet 4 comprising a second major surface 4a. These major glass sheet surfaces 3a, 4a faces each other and the evacuated gap 6. The glass sheets 3, 4 each comprises a major surface 3b, 4b facing away from the evacuated gap 6.

The support structures 5 are arranged distributed between the surfaces 3a, 4a, often in a predefined pattern with predetermined mutual distances, and maintains a distance between the glass sheet surfaces 3a, 4a upon gap 6 evacuation. The glass sheets 3, 4 are sealed together at the periphery of the glass sheets 3, 4. The sealing together of the first and second glass sheets 3, 4 may comprise use of an edge seal material 7 as described above, or it may comprise fusing the glass sheets directly together. In some embodiments, the sealing together of the glass sheets may comprise locally heating at least at the edge seal location, or heating the entire VIG unit assembly including the support structures to a desired temperature in e.g. a furnace. If the glass sheets are thermally tempered glass sheets, this furnace temperature may be set to be below a temperature where the glass sheets de-tempers. The sealing together of the glass sheet 3, 4 edges may provide a fused, rigid edge seal. Other airtight edge seal solutions may alternatively be provided.

The glass sheets 3, 4 may be annealed glass sheets or tempered glass sheets, such as thermally tempered glass sheets. One or both glass sheets 3,4 may have a thickness between 1 mm and 6 mm, such as between 2 mm and 4 mm, for example between 2.5 mm and 3.5 mm including both end points. The glass sheets 3, 4 may be of the same or different thickness.

Thermally tempered glass may have a glass sheet surface 3a with an unevenness of at least 0.1 mm, such as at least 0.2 mm, for example at least 0.3 mm. this may occur due to one or more of glass sheet bowing, glass sheet warp, glass sheet edge lift and/or the like that may e.g. occur during tempering of the glass sheet to obtain a thermally tempered glass sheet.

In some embodiments, the glass sheet 3, 4 surface 3a, 4a unevenness for each glass may even be equal to or larger than the support structure 5 height H1 (or H2, see further below).

In some embodiments, the glass sheet surfaces 3a, 4a may comprise one or more low-e coatings and/or the like to e.g. provide advantageous/desired heat regulation and/or other functionalities. It is understood that one or both contact surface(s) 5a, 5b may abut such coatings of the glass sheet. In other embodiments, the glass sheet surface abutting the contact surface of the support structure may be uncoated.

The gap 5 has been evacuated to a reduced pressure by the pump 11. In embodiments of the present disclosure, the pressure in the gap 5 may be below 0.05 mbar, such as below 0.005 mbar, such as 0.003 or 0.001 mbar or below after the evacuation of the gap and sealing of the gap 6.

After the evacuation, the evacuation outlet 6a is sealed by a sealing 6b, such as at least partly by means of a solder material. In FIG. 3 and FIG. 4, the evacuation outlet 6a is illustrated in a glass sheet 3, in other embodiments, the evacuation outlet may be provided in the edge seal material or between the edge seal material and one of the glass sheets 3, 4.

The support structures 2 maintains a distance between the glass sheet surfaces 3a, 4a across the evacuated gap 6 when the gap has been evacuated by means of their height. The distance between the glass sheet surfaces 3a, 4a after gap 6 evacuation may in embodiments of the present disclosure be 0.5 mm or below, such as 0.3 mm or below, for example 0.2 mm or below.

One square meter VIG unit may often contain more than 500 such as more than 500 or more than 3000, such as between 500-3000 discretely distributed support structures.

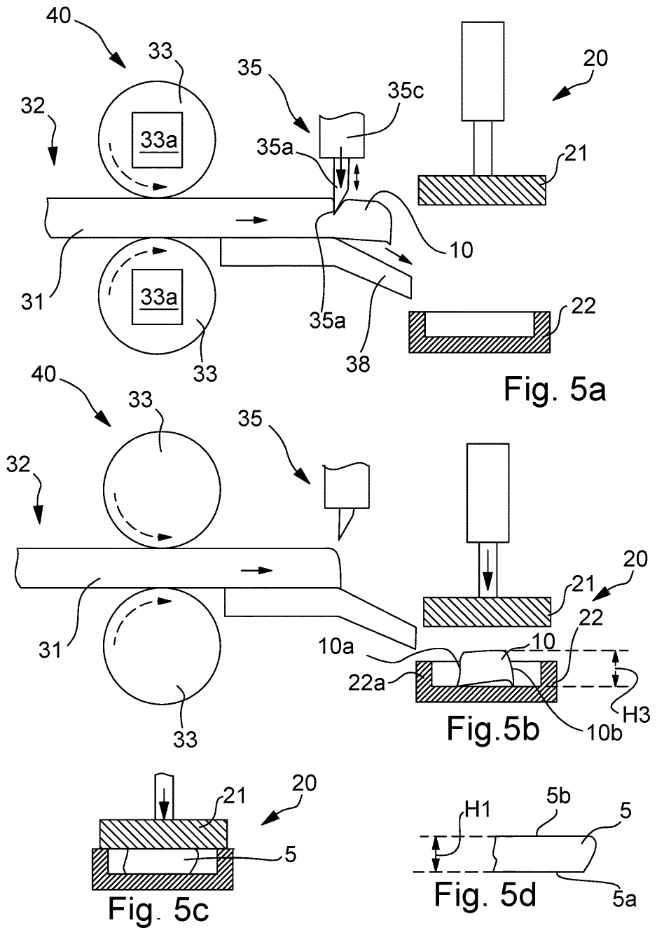

FIGS. 5a-5c illustrates schematically various embodiments of the present disclosure, wherein support structure workpieces 10 are separated from source material and then deformed by a deformation unit 20.

In FIG. 5a, a source material 31, such as a filament or wire 31 is fed from a source material storage 32. The storage 32 may e.g. be a space comprising a rolled up source material 31, e.g. rolled up on a roll or in a spiral, it may be linearly extending source material 31 and/or the like. The source material 31 may e.g. be a metal filament such as a metal wire, such as a steel wire or filament, it may be a polymer wire or filament and/or the like. The source material 31 may in embodiments be of one solid unitary/monolithic structure that is coated or uncoated.

The cross sectional shape of the source material 31 may in embodiments of the present disclosure e.g. be circular shaped, polygonal shaped, or the like such as triangular shaped, rectangular, hexagonal shaped, trapezoidal, square shaped or the like.

The source material 31 is fed by a feeder towards a workpiece material cutter 35. This is provided by means of a feeding device 40 which feeds the source material 31 from the storage 32 towards the cutter 35. In FIG. 5a-5b, the feeding device 40 comprises one or more pushing and/or pulling rolls 33. One or both rolls 33 may be driven by a drive motor 33a to force/move the source material towards the cutter 35. More rolls 33 may be provided in further embodiments. Other types of feeding devices 40 may be provided in further embodiments, such as e.g. by magnetically driving the source material 31 towards the cutter, by using reciprocating drive members, by means of a belt or chain drive and/or the like (not illustrated).

The cutting device 35 comprises a cutting knife 35 with one or more cutting edges 35b. The cutting edge is controlled by a knife moving unit 35c such as a linear actuator, a motor and/or the like. The knife moving unit 35c is controlled to move the knife edge 35b into the source material 31 opposite the edge to cut support structure workpieces 10 from the source material 31.

In some embodiments, the cutting device 35 may comprise a scissor cutting mechanism, a stamping, such as punching cutter and/or the like.

A guiding path 38, such as a pipe, slideway (as illustrated) or the like guides the cut off workpiece 10 to the support 22.

As illustrated in FIG. 5b, the workpiece has the initial maximum height H3 before deformation by the deformation unit 20. This height H3 may e.g. be defined by the cross sectional shape and/or size of the source material 32, but it may possibly also, in some embodiments, deviate at least partly from that shape due to the cutting operation by means of the cutter 35. In some embodiments, the distance between cut surfaces of the workpiece 10 may also define the initial height H3, this may e.g. be provided the length of workpiece 10 that is cut from the source material 31. In some embodiments, the cut off surfaces 10a, 10b of the workpiece may be used as the surfaces for the contact surfaces of the support structure. In FIG. 5b however, it is the outer uncut surface that made up the cross sectional shape of the source material 31 that is used for shaping the contact surfaces 5a, 5b.

FIG. 5c illustrates that the deformation unit 20 deforms the workpiece 10 cut from the source material 31. Thereby, a support structure 5 as seen in FIG. 5d which has a desired height H1 that is less than the initial workpiece height H3, is obtained.

It is understood that timing of speed and/or start/stop of the feeding device 40 may e.g. be provided by controlling the drive 33a. Additionally or alternatively, timing of the cutting operation may be provided in order to provide a workpiece 10 at a desired time and/or of a desired size.

As can be seen from e.g. FIGS. 1c and 5c, the deformation of the support structure workpieces 10 by the deformation unit 20 may in embodiments of the present disclosure provides oppositely, directed contact surfaces 5a, 5b. These contact surfaces may e.g. be substantially parallel, contact surfaces 5a, 5b at each support structure 5. One or both of the contact surfaces 5a, 5b may in other embodiments be slightly curved such as convex (not illustrated), or comprise another desired shape at last partly defined by the design of the deformation unit 20 such as the design of the support 22 and/or press 21.

In some embodiments, the area of each contact surface 5a, 5b may makes up 50% or more of the support structure silhouette when seen perpendicular to the contact surface. In some embodiments the contact surface area of one or both surfaces 5a, 5b may make up 95% or less, such as 85% or less or 75% or less of the support structure silhouette when seen perpendicular to the contact surface. In some embodiments of the present disclosure, the deformation of the support structure workpieces by the deformation unit provides at least one plane contact surface. This may be achieved by the initial shape of the workpiece 10 and/or the constitution and/or setting of the deformation unit. In some embodiments the contact surface area of one or both surfaces 5a, 5b may make up 95% or more of the support structure silhouette when seen perpendicular to the contact surface. This may depend on the initial shape of the workpiece.

The support structures 5 are plastically deformed by the deformation unit 20 to have a first, desired, predetermined support structure height H1, that is less than the initial maximum height H3 (see e.g. FIGS. 1c and/or 5b) of the workpiece 10.

The support structures 5 are placed at the surface 3a so that they support on one of the contact surfaces 5a, 5b, and the height H1, such as a maximum height, extends between/is defined between these contact surfaces 5a, 5b. See e.g. FIGS. 2-5.

The deformation of the support structure workpieces 10 by the deformation unit 20 may in embodiments of the present disclosure provide an at least 5% reduction of the initial maximum height H3 of the support structure workpiece 10 into a first support structure height H1, such as an at least 20%, such as an at least 40% reduction of the initial maximum height H3 of the support structure workpieces 10.

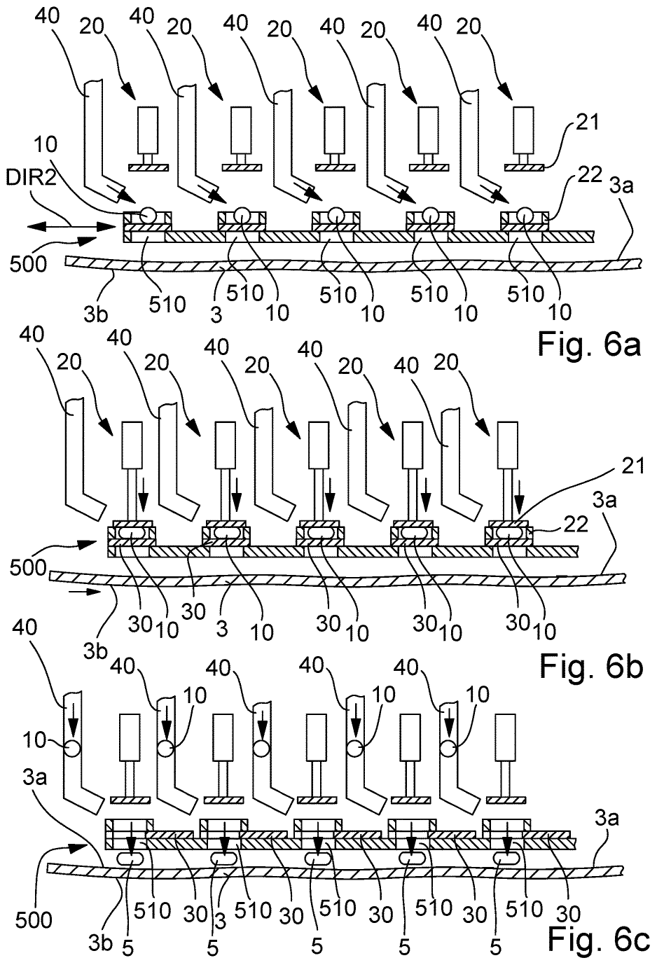

FIG. 6a-6c illustrates schematically embodiments of the present disclosure wherein a plurality of dispenser outlets 510 are arranged in a dispenser array 500. In this embodiments, the outlets 510 area arranged side by side, transverse to a movement direction of the glass sheet 3 (or the array 500) in a direction along the glass sheet surface 3. The outlets 510 are hence arranged e.g. side by side in a dispenser distribution direction DIR2 that may be transverse to the movement direction with which a motor or the like provides a relative displacement between the array and the glass sheet 3 along the glass sheet surface 3a.

The outlets 510 of the array 500 are placed with a mutual distance and may dispense a row of support structures 5 at a time, for example simultaneously, onto the glass sheet surface 3a. The mutual outlet 510 distance defines the support structure distance at the major glass sheet surface 3a.

The array 50 may in embodiments of the present disclosure comprise between 4 outlets 510 and 80 outlets 510, such as between 4 outlets 510 and 50 outlets 510, such as between 6 outlets 510 and 30 outlets 510. Each outlet 510 may be part of/comprised in an individual support structure 5 dispensing system or be provided at a single dispensing system.

A movable support structure retainer 30 retains the respective support structure until it is desired to be dispensed/dropped towards the surface 3a. The movable retainer may be controlled by means of an actuator such as a linear actuator or a motor (not illustrated). In some embodiments, the retainer may comprise a magnetizing unit or the like if the support structure 5 is magnetic.

As illustrated in FIG. 6a, workpieces 10, in this case a spherical ball as previously disclosed, but it may also be cut off pieces or workpieces of another shape, enters into the support 22 from a feeding device 40. The feeding device may comprise a workpiece storage 32, or the like as e.g. previously described. Individual deformation units 40 then deforms the respective workpiece 10 into a support structure 5, see FIG. 6b. Afterwards, the deformed support structures 5 are released towards the surface 3a when desired by controlling the support structure retainer 30. In FIG. 6c, the support structure retainer 30 also acts as a counter hold providing a surface of the deformation unit so that the workpiece 10 is deformed between the retainer 30 surface and the press part 21. In other embodiments, the retainer 30 may be separate to the deformation unit, and a feeding part (not illustrated) may assure that the deformed workpiece/support structure 5 is supplied to the retainer 30, e.g. by gravity, air pressure, suction and/or the like to be ready to be dispensed.

The array 500 may help to increase VIG unit production/manufacturing speed and/or VIG unit assembly production/manufacturing speed.

It is generally understood that in some embodiments of the present disclosure, an intermediate support structure storage/buffer (not illustrated) comprising a plurality of support structures received from the deformation unit 20 may be placed between the deformation unit 20 and the glass sheet to be provided with the support structure. A dispenser may then dispense support structures from this storage/buffer towards the glass surface 3a. In other embodiments, such a buffer/storage may be omitted as e.g. illustrated in FIGS. 6a-6c.

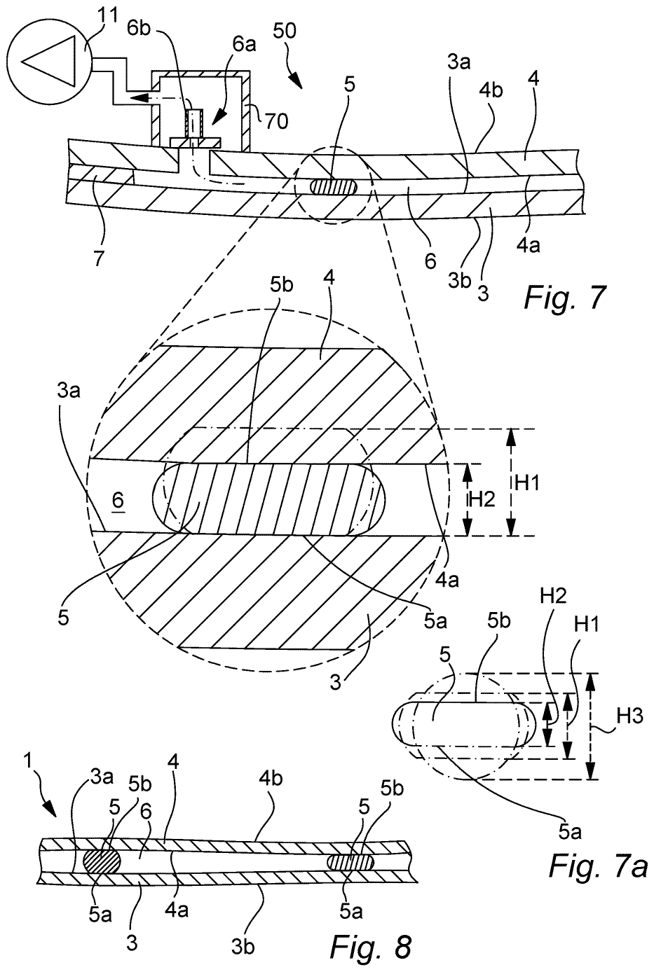

FIG. 7 illustrates schematically a cross section of an evacuation of the gap 6 of the VIG unit according to embodiments of the present disclosure. A fluid path between an evacuation pump 11 and an evacuation cup 79 is provided. The evacuation cup covers a pump out port 6a over which a sealing system 6b is arranged. In FIG. 7, the sealing system comprises a tube such as a metal tube or a glass tube, and solder material. When this sealing system is heated by a heater, e.g. a heater inside the cup 70 (not illustrated), the gap 6 is sealed. The pump evacuates the gap 6.

This evacuation gradually provides, in embodiments of the present disclosure, a further, second deformation, such as a plastic deformation, of one or a plurality of the support structures as the pressure in the gap is reduced in the gap, so the support structure height H1 provided by the deformation unit is further reduced to a second height H2. This further second deformation is hence provided/obtained by means of the pump 11. When the pump 11 evacuates the gap, this induces a compression force onto the support structures by means of the glass sheet surfaces 3a, 4a when the gap is evacuated while the VIG unit assembly is in a surrounding pressure such as atmospheric pressure.

In embodiments of the present disclosure, the second deformation may provide an at least 10%, such as at least a 20%, for example at least a 30% reduction of the initial support structure height H1 that was obtained by means of the deformation unit 20. This deformation may be subjected to each support structure 5 of a group, such as a subgroup, of the support structures 5 placed in the gap.

This may help to adapt the support structure height H1 to the individual characteristics of each glass sheet 3, 4 combination. This may e.g. be relevant if the glass sheets 3, 4 are thermally tempered glass sheets, so as to adapt to the surface 4a, 3a variation/unevenness caused by the glass sheet tempering process.

For example, in some embodiments, the further, second deformation of the support structure height H1 provided by means of the pump 11 when the gap is evacuated may provide a between 20% and 70%, such as between 30% and 70%, for example between 40% and 60% reduction of the first height H1 of a group, such as a subgroup, of the support structures placed in the gap.

For example, in some embodiments of the present disclosure, at least 2% such as at least 10% or at least 30% of the support structures 5 in the evacuated gap 6 may be subjected to the further deformation to go from having the first height H1 to having a reduced, second height H2, and this may be a may be a plastic support structure deformation. In some embodiments, at least 5%, such as at least 10%, such as at least 25% of the total amount of support structures 5 of the vacuum insulated glass unit 1 have been subjected to the further, second deformation. In one or more embodiments of the present disclosure, between 5% and 95%, such as between 15% and 80%, for example between 20% and 60% of the total amount of support structures of the VIG unit assembly may be subjected to said further deformation by means of the pump.

As FIG. 7a schematically illustrates, overall deformation from the initial maximum workpiece height H3 to the final support structure 5 height H2 in the evacuated VIG unit gap 6 may be provided by initially reducing the workpiece height H3 into the support structure height H1, and from there to the support structure height H2 that is adapted in the gap during gap evacuation.

The overall deformation into the final support structure 6 height H2 may provide that each support structure 5 of a group, such as a subgroup, of the support structures 5 placed in the gap 6 has a height H2 that is least 20% smaller, such as at least 30%, smaller for example at least 40% smaller than the initial maximum height H3 of the respective workpiece.

FIG. 8 illustrates schematically an embodiment of the present disclosure wherein the support structures 5 in the evacuated gap 6 of a VIG unit 1 have different heights, such as by means of plastic support structure deformation. This different support structure height may in embodiments of the present disclosure at least partly be provided by means of the further deformation described above so that the final height H2 of the support structures 5 is adapted to the surface characteristic of the glass sheets 3, 4. In other embodiments, the support structure height H1 obtained by means of a deformation unit may substantially not be changed in the VIG unit gap, or it may be subjected to merely elastic deformation.

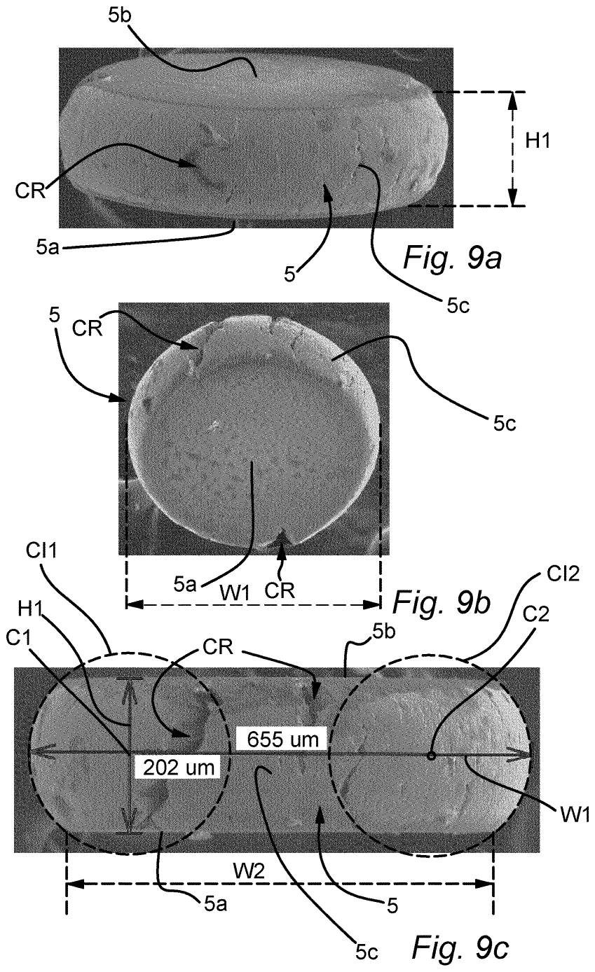

FIGS. 9a-9c and FIGS. 10-11 illustrates microscopic images of a support structure 5 according to various embodiments of the present disclosure where a deformation unit 20 has plastically deformed a spherical, solid steel ball into a support structure having the desired height H1. The initial steel ball was here a precision steel ball having a diameter of 0.4 mm, but other ball diameters may be used in other embodiments of the present disclosure, as e.g. described previously in this document. The compression/deformation of the steel ball by means of coining the solid steel ball provided the substantially plane contact surfaces 5a, 5b. The microscope may be a stereo microscope or a dyno light microscope.

The inventor found that some cracks CR may occur in the side surface 5c of the support structure 5 when it is deformed, but such cracks was generally not found to reduce the desired structural performance of the support structure/spacer 5. The side surface 5c extends between the opposing contact surfaces 5a, 5b, and extends in the present example convexly, such as bulging, between the surfaces 5a, 5b.

The side surface 5c is bulging, and in a cross sectional view, the side surface 5c describes an arc, such as substantially a circular arc, between the surfaces 5a, 5b at both sides of a support structure cross section. See FIG. 9c where the cross section can be imagined as the silhouette of the support structure 5 seen from the side towards the side surface 5c. The side surface 5c arc described by the surface 5c between the contact surfaces 5a, 5b may substantially be an arc of/comprised in a circle CI1, CI2, and these circles have non-coinciding centres C1, C2. This may be caused by the plastic deformation by means of the deformation unit 20, in this case by deforming a spherical ball.

The circles CI1, CI2 may as illustrated, in embodiments of the present disclosure have a diameter that is larger than the support structure height H1 (or H2). The side surface 5c arc extending between the contact surfaces may have a length that is larger than the height H1 (or H2), such as at least 1.1 or at least 1.3 times the height H1 (or H2).

As can be seen from FIG. 9c, the support structure 5 has a width W1. As the support structure 5 in embodiments of the present disclosure as illustrated in FIGS. 9a-9c may have an outer circular side periphery described by the side surface/side edge surface 9c extending between the contact surfaces 5a, 5b, the width W1 may be a maximum diameter.

In embodiments of the present disclosure, the maximum width W1, such as the maximum diameter, of the support structure 5 may be larger than the height H1 provided after the deformation of the spacer/support structure 5, such as at least 1.3, times, such as at least 1.5 times or at least 1.8 times larger than the height H1 of the support structure 5.

In embodiments of the present disclosure, the maximum width W1, such as the maximum diameter, of the support structure 5 may be between 1.3 and 6 times, such as between 1.5 and 6 times, for example between 2 times and 4 times larger than the height H1 of the spacer 2.

In embodiments of the present disclosure, the maximum width W1, such as the maximum diameter, of the support structure 5 may be at least 2 times, such as at least 2.4 times or at least 2.8 times larger than the height H1 of the support structure 5.

In FIG. 9c, the maximum width W1, such as the maximum diameter, of the support structure 5 is about W1/H1 0.655 mm/0.202 mm=3.2 times larger than the height H1 of the support structure 5.

The increased maximum width W1 when compared to the support structure height H1 obtained by means of the deformation by the deformation unit as e.g. previously described may be provided at least partly due to the deformation of the workpiece so that the plastic deformation of the workpiece due to the deformation provides a “flow” of workpiece material that result in a support structure width W1 that is larger than the initial workpiece width, such as diameter.

In FIG. 9c, the width W2 (such as diameter) of the contact surfaces 5a, 5b is less than the maximum width W1 (such as diameter) of the support structure, as the maximum width W1 is determined between the bulging side surfaces.

In some embodiments, the width W2 (such as diameter) of the contact surfaces 5a, 5b may be between 0.6 and 0.96 times the maximum width W1 (such as diameter) of the support structure, such as between 0.7 and 0.9 times the maximum width W1 (such as diameter) of the support structure.

For example, the width (such as diameter) W2 of the contact surfaces 5a, 5b may be less than 0.95 times, such as less than 0.8 times, for example less than 0.6 times the maximum width W1 (such as diameter) of the support structure 5.

In some embodiments, the width W2 (such as diameter) of the contact surfaces 5a, 5b may be larger than 0.4 times, such as larger than 0.5 times, for example larger than 0.6 times the maximum width W1 (such as diameter) of the support structure 5.

As can be seen from e.g. FIG. 9b and other of the figures described above and/or below, in some embodiments of the present disclosure, the contact surface 5a, 5b area after workpiece deformation may make up 50% or more of the support structure 5 silhouette when seen perpendicular to the respective contact surface 5a, 5b.

It is generally understood that in embodiments of the present disclosure, the support structures 5 may have a support structure height H1 after the deformation by the deformation unit of less than 0.6 mm, such as less than 0.5 mm such as less than 0.3 mm, such as less than 0.25 mm. For example, the support structure/spacer height H1 may be 0.2 mm or less.

The compressive load on each of at least 50%, such as at least 70% of the support structures 5 in an evacuated VIG unit (see FIG. 2c) gap, for a cylindrical support structure or a support structure 5 with curved outer side edge surface 5c and plane contact surface 5a, 5b as illustrated in several of the figures described above, in a “square support structure grid” of 40×40 mm2 (i.e. distance of substantially 40 mm between neighbouring/adjacent support structures 5, may amount to at least 0.5 GPa, such as at least 0.8 GPa, such as substantially 1 GPa. In some embodiments, the compressive load on at least 80% or 90%, such as substantially all support structures of the VIG unit may be between 0.5 GPa and 2 GPa, such as between 0.6 and 1.3 GPa.

It is generally understood that the tolerances for the support structure height Hl may be ±30 micron, such as ±20 micron, or ±10 micron or less. For example, spacer/support structure 5 height H1 may be 0.2 mm with a ±25 micron, such as ±20 micron, or ±10 micron tolerance. For example, maximum support structure width W1 may be 0.44 mm or 0.66 mm with a ±40 micron, such as ±20 micron, or ±10 micron tolerance. The tolerances of the spacer/support structure 5 width W1 may in some embodiments of the present disclosure be less restrictive than the tolerance requirements to the spacer/support structure 5 height H1.

It may be so that contact surfaces 5a, 5b and/or support structures 5 are shaped/designed so as to not allow to trap pockets of gasses between glass surface and pillar surface, and hence the contact surface 5a, 5b flatness may in embodiments of the present disclosure be substantially flat and/or comprise one or more grooves/furrows and/or the like to reduce the risk of trapping gasses in between the glass sheet surfaces 3a, 4a and the contact surfaces 5a, 5b.

Outgassing from the support structure 5 should be minimized. Particularly outgassing of non-getterable species should be avoided for example argon.

In one or more embodiments of the present disclosure, the maximum width W1 of the support structure 5 after the workpiece 10 deformation by the deformation unit 20 is larger, such as at least 3% larger, for example 20 % larger, such as at least 35% larger or at least 100% larger than the initial width D1 of the workpiece before the workpiece deformation.

In one or more embodiments of the present disclosure, the maximum width W1 of the support structure 5 after the workpiece 10 deformation by the deformation unit 20 is at least 40% larger, for example at least 50% larger, such as at least 80% larger than the initial width D1 of the workpiece before the workpiece deformation.

In one or more embodiments of the present disclosure, the maximum width W1 of the support structure 5 after the workpiece 10 deformation by the deformation unit 20 is between 3% and 120% larger, such as between 5% and 85% larger, for example between 20% and 65% larger than the initial width D1 of the workpiece 10 before the workpiece deformation.

In one or more embodiments of the present disclosure, the maximum width W1 of the support structure 5 after the workpiece 10 deformation by the deformation unit 20 is between 10% and 85% larger, for example between 20% and 70% larger than the initial width D1 of the workpiece 10 before the workpiece deformation.

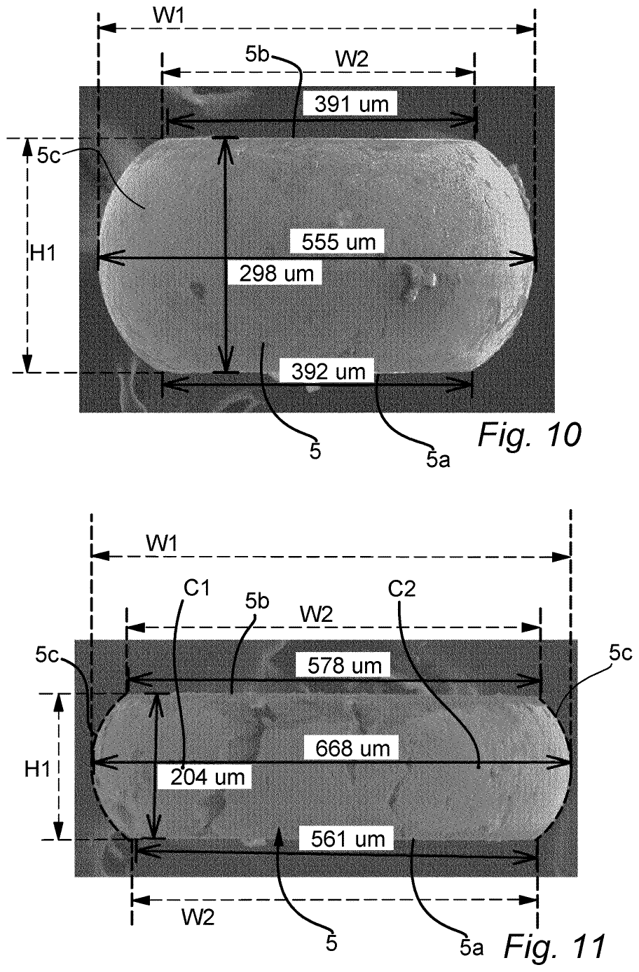

FIG. 10 illustrates an image of a support structure 5 according to embodiments of the present disclosure, where the support structure 5 was made from an initial workpiece being a spherical, solid metal ball of a diameter of 0.4 mm. After deformation by means of a deformation unit, the support structures has a height of 298 microns, i.e. approximately 0.3 mm. the maximum support structure width W1 is here 555 microns, corresponding to about 0.6 mm. The contact surface area 5a, 5b width W2, such as the diameter of the contact surfaces is about 391 and 392 microns respectively, corresponding to about 0.4 mm.

FIG. 11 illustrates an image of a support structure 5 according to embodiments of the present disclosure, where the support structure 5 is made from an initial workpiece being a spherical, solid metal ball of a diameter of 0.4 mm. After deformation by means of a deformation unit, the support structure 5 has a height of 204 microns, i.e. approximately 0.2 mm, the maximum width W1 is here 668 microns, corresponding to about 0.7 mm. The contact surface width W2, such as the diameter of the contact surfaces 5a, 5b is about 578 and 561 microns respectively, corresponding to 0.6 mm.

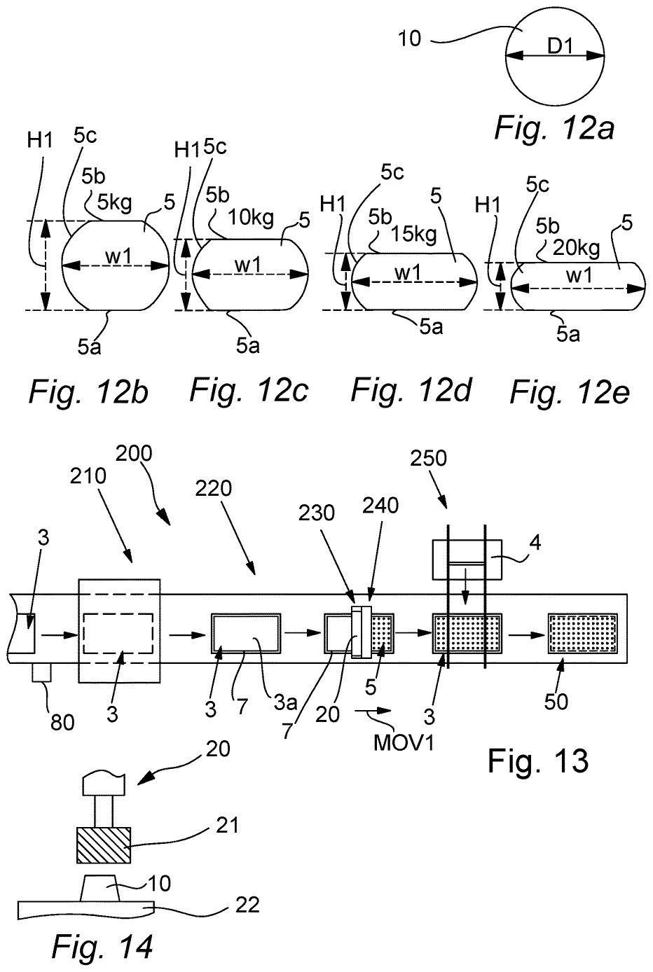

FIG. 12a illustrates an initial special, massive steel ball for use as a VIG unit support structure workpiece 10 according to embodiments of the present disclosure. The spherical ball 10 has a diameter D1 of for example 0.4 mm.

FIGS. 12b-12e illustrates the silhouette/contour of the ball of the type of FIG. 12a, and are the contour silhouette/contour of the ball which are drawn up based on microscopic images of spherical solid steel balls that have been plastically deformed by different loads. As can be seen, as the deformation load/force provided by e.g. the deformation unit 20 increases from 5 kg to 20 kg, the contact surface 5a, 5b area increases, the support structure height H1 decreases, and also the maximum support structure width W1 increases.

FIG. 13 illustrates schematically a manufacturing line 200 for a VIG unit according to various embodiments of the present disclosure. The first glass sheet 3 first enters a first station 200 where edge seal material 7 such as solder glass edge seal material or metal solder edge seal material is provided to the upwardly facing major glass sheet surface 3a.

Then the glass sheet 3a is moved to a support structure placement station 240 where one or more support structure dispensers, such as a dispenser system array 500 as previously described, dispenses support structures onto the major surface 3a. This is provided so that the support structures 5 are placed at the surface 3a with a mutual, desired distance in e.g. rows and/or columns on the glass sheet surface 3a, or in another desired pattern. A relative movement MOV1 may be provided by means of a motor 80 to provide a relative movement between the one or more support structure dispensers and the glass sheet in a direction along the glass sheet surface 3a.

At glass pairing station 250, the glass sheets 4 and 3 are paired by placing the second glass sheet 4 on top of the first glass sheet 3 to cover the support structures 5. The glass sheet 4 may e.g. rest on the edge seal material 7. The glass pairing station 250 may comprise automation systems such as one or more of a robotic arm, one or more linear displacement members, one or more rails and/or the like for transporting the glass sheet 4 to the position opposite the surface 3a and lowering the glass sheet towards the surface 3a.

After this, the edge seal material 7 of the VIG unit assembly 150 may be heated and the gap is evacuated to a reduced pressure as e.g. previously described (not illustrated in FIG. 13. It is understood that the edge seal material, if even needed, may be placed/applied subsequent to placing the support structures at station 240 instead. It may even in some embodiments be provided in an evacuation chamber or be omitted if the glass sheets are fused directly together by a glass sheet 3, 4 edge melting operation.

In embodiments of the present disclosure, the deformation unit(s) 20 may as illustrated be arranged at a workpiece deformation station 230 at the manufacturing line 200. The deformation station 230 provides the support structure workpiece 10 deformation during vacuum insulated glass unit assembly 50 manufacturing at the line 200 prior to arranging the resulting support structures 5 at the glass sheet 3a, e.g. as previously described according to various embodiments of the present disclosure.

The deformation unit(s) 20 of the deformation station 230 provides the support structure workpiece 10 deformation to provide support structures 5 to be placed at a first glass sheet 3, for example while the glass sheet 3 is arranged at the VIG unit assembly 50 manufacturing line 200. The resulting support structures are then placed at the first glass sheet 3 surface 3a by the support structure placement arrangement station 240 in the VIG unit manufacturing line.

In some embodiments, the deformation unit(s) 20 of the station 230 may provide the support structure workpiece 10 deformation to produce support structures 5 to be placed at a first glass sheet 3 after said first glass sheet 3 has been arranged at the support structure placement station 240 or the deformation station 230. In some embodiments, the deformation station and the placement station 240 may be at the substantially same location in the manufacturing line 200.

In one or more embodiments, for example, the deformation unit(s) 20 may provide the support structure workpiece 10 deformation to produce support structures 5 to be placed at a first glass sheet 3 while the first glass sheet 3 moves through or into a support structure 5 placement station 240. In other embodiments, the deformation of support structures 5 to be placed at a glass sheet surface 3a may be provided prior to the glass sheet 3 entering the station 240, for example while edge seal material 7 is provided, while glass sheet cleaning (not illustrated) is provided and/or the like.

The deformation of the support structure workpieces 10 may in embodiments of the present disclosure be provided by consecutively feeding and deforming, such as coining, the support structure workpieces 10 in a continuous feeding and deformation process. This may be provided during vacuum insulated glass unit assembly 50 manufacturing at the vacuum insulated glass unit assembly 50 manufacturing line 200.

FIG. 14 illustrates a workpiece 10 arranged at a deformation unit 20 to be deformed, where the workpiece 10 has a predefined shape different from spherical. In FIG. 14, the workpiece is partly conical.

In embodiments of the present disclosure, the workpieces 10 to be deformed may comprise cylindrical workpieces, rectangular workpieces, conically shaped workpieces such as workpieces that are pyramid shaped, cone shaped workpieces, such as shaped as a frustum of a cone or a pyramid, oval workpieces and/or the like. The workpieces be cut from e.g. a wire/filament (see e.g. FIGS. 5a-5d and the description thereto), may have a spherical shape such as be spherical balls and/or the like. The workpieces 10 are provided with an initial shape that is to be adapted by the deformation unit.

It is understood that the workpiece 10 in embodiments of the present disclosure may comprise one or more initial, predefined, flat such as substantially plane, surfaces that maybe enlarged by the deformation unit into contact surfaces 5a, 5b during the workpiece deformation. In other embodiments, e.g. where spherical balls are used as workpieces as e.g. illustrated in FIGS. 1a-1c, such an initial predefined surfaces may not be present at the workpiece.

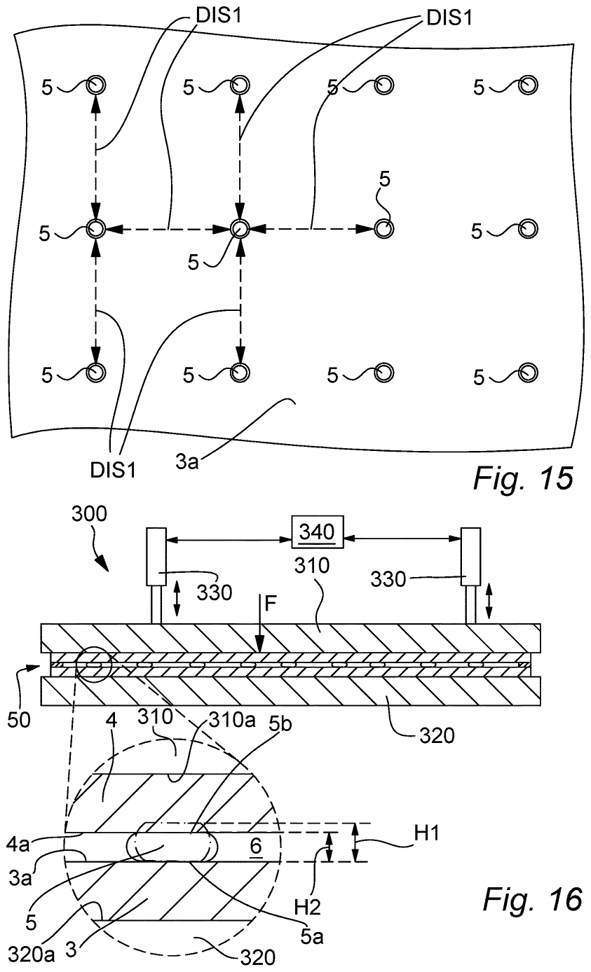

FIG. 15 illustrates a square support structure grid arranged at a major surface 3a according to embodiments of the present disclosure. The support structures 5 are arranged with a mutual distance DIS1. The distance DIS1 may in embodiments of the present disclosure be at least 30 mm. For example, the distance DIS1 may be between 30 mm and 60 mm such as between 30 mm and 60 mm, such as between 35 mm and 45 mm, for example between 38 mm and 42 mm.

FIG. 16 illustrates schematically a further, second support structure 5 deformation according to embodiments of the present disclosure. In FIG. 7, the further, second support structure deformation to obtain the support structure height H2 is provided by means of the evacuation pump which evacuates the gap. In the embodiment of FIG. 16, an external mechanical pressing arrangement 300 comprising pressing bodies 310, 320 such as pressing plates, and actuators 330 provides the second support structure deformation to obtain the support structure height H2. The bodies 310, 320 may e.g. comprise metal bodies or bodies of another material.

Two actuators 330 are illustrated in FIG. 16, but it is understood that in further embodiments, only one actuator 330, or more than two actuators 330, may be provided in further embodiments. The pressing bodies 310, 320 comprises pressing surfaces 310a, 320a, and one or both pressing bodies is/are configured to move towards and away from each other so as to increase or reduce the distance between the pressing surfaces 310a, 320a. This movement is provided by means of the one or more actuators 330.

A VIG unit assembly 50 comprising the glass sheets 3, 4 (that may e.g. be annealed glass sheets or thermally tempered glass sheets) and the support structures 5 distributed between the glass sheets 3, 4 is placed between the pressing plate 310, 320 surface 310a, 320a. The support structures 5 of the VIG unit assembly 50 when the assembly is placed in the pressing arrangement 300 have the initial support structure height H1.

One or more actuators 330 are controlled by a hardware controller (340 so that the distance between pressing surfaces 310a, 320a of the pressing bodies 310, 320 is reduced. This provides a compression force F towards the major exterior surfaces of the glass sheets of the VIG unit assembly 50 that faces away from the gap 6. This compression force F provides that the major glass sheet surfaces 3a, 4a facing the gap 6 provides a plastic deformation of the support structures 5 in the gap 6 so that the height H1 of the support structures is reduced to a second, reduced height H2. This provides an individual adaption of the spacer height to the surface 3a, 4a topography of the glass sheets 3a, 4a.

The hardware controller 340 controls the actuator(s) 330, e.g. based on a software program code stored in a data storage (not illustrated).

In one or more embodiments of the present disclosure, one or more load sensors (not illustrated) may be configured to directly or indirectly detect the amount of force F provided to the assembly 50. For example, in some embodiments, the one or more load sensors may comprise a processing unit receiving/retrieving electric current consumption information obtained from the actuator(s), it may comprise one or more strain gauges and/or the like. In some embodiments, such load sensor(s) may provide feedback to a closed control loop system of a controller 340 controlling the actuator(s) 330. The compression force F, such as a maximum compression force, applied by means of the actuator(s) 330 may in embodiments of the present disclosure be a predetermined compression force. The predetermined compression force may be based on one or more parameters stored in a data storage such as the above mentioned data storage. The one or more parameters may e.g. be related to the distance between adjacent spacers 5 in the gap, the support structure material, support structure size and/or the like.

In some embodiments, the hardware controller may control the actuator(s) to gradually increase the force F to the predetermined compression force such as a predetermined maximum compression force. This may e.g. be provided by ramping up the force applied from an initial lower force.

The magnitude of the plastic deformation from the height H1 into the height H2 may in embodiments of the present disclosure be as described in relation to one or more embodiments described above, e.g. in relation to FIGS. 7 and/or 7a.

In FIG. 16, the actuator(s) 330 is/are controlled so that the top press plate 210 moves towards the lower plate 320. In other embodiments of the present disclosure, the actuator(s) 330 may be directly or indirectly connected to the lower pressing plate 320 instead, and the lower plate 320 may hence be moved, together with the VIG unit assembly 50 supporting thereon, towards the upper pressing plate 310. In further embodiments of the present disclosure, one or more actuators 330 may be provided and configured to move one or both bodies 310, 320, and both pressing bodies 310, 320 may be movable towards and/or away from each other.

In some embodiments of the present disclosure, the external mechanical pressing arrangement 300 may provide some of the further, second plastic deformation into the height H2, or most, such as substantially all of the further, second plastic deformation into height H2. In some embodiments, the further, second deformation, such as plastic deformation, may be provided partly by means of an evacuation pump evacuating the gap (e.g. as described above in relation to the description of FIG. 7) and partly by the external mechanical pressing arrangement 300.

The actuator(s) 330 may in embodiments of the present disclosure be or comprise an pneumatic actuator, a hydraulic actuator, an electric actuator or the like. It may or may not comprise a gearing.

In one or more embodiments of the present disclosure, one or more load sensors are configured to directly or indirectly detect the amount of force F provided, e.g. by means of electric current consumption information obtained from the actuator system, by means of one or more strain gauges and/or the like. In some embodiments, such load sensors may provide feedback to a closed feedback control system of a controller 340 controlling the actuator(s) 330. The compression force F, such as a maximum compression force, applied by means of the actuator(s) 330 may in embodiments of the present disclosure be a predetermined compression force. The predetermined compression force may be based on one or more parameters stored in a data storage. The one or more parameters may e.g. be related to the distance between adjacent spacers 5 in the gap, the support structure material, support structure size and/or the like.

In one or more embodiments of the present disclosure, a resilient sheet (not illustrated) may be placed between the respective pressing surface 310a, 320a and the respective major exterior glass sheet 3, 4, surface facing away from the gap 6. This my e.g. help to distribute forces and/or protect glass sheet surfaces.

It is generally to be understood that the VIG unit may e.g. be transparent to at least visible light.

In embodiments of the present disclosure, the manufactured VIG unit may be for use in a building window. In some embodiments, the building window may be a roof window. In other embodiments, the building window may be a vertical window such as a façade window. In some embodiments, the VIG unit when used in a building window may be laminated at one or both sides of the VIG unit by means of an interlayer and a further glass sheet. In other embodiments of the present disclosure, the VIG unit may be used for e.g.

cooling furniture such as in a door of a refrigerator or freezer and/or for heating furniture such as in a door of an oven. The VIG unit to enable a view through the VIG unit towards the goods stored in the interior of the cooling or heating furniture.

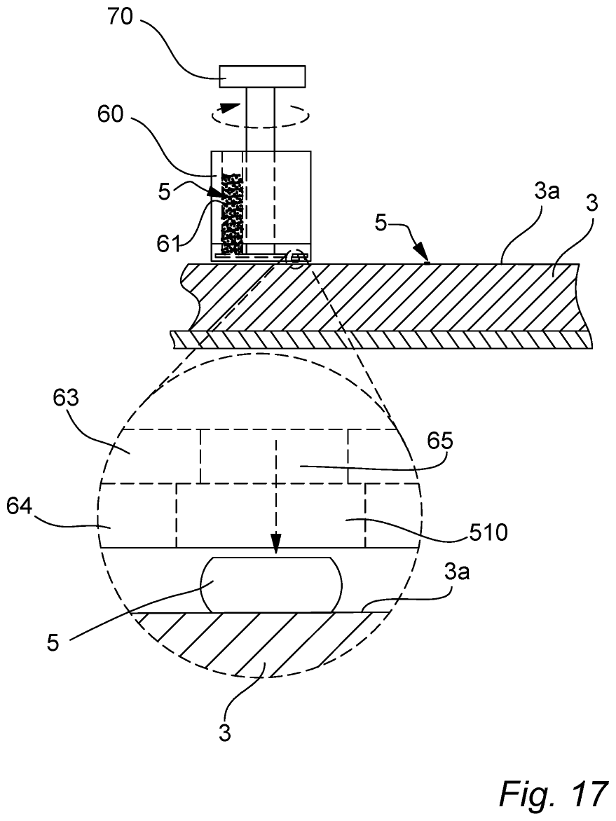

FIG. 17 illustrates schematically an embodiment of the present disclosure, wherein a plurality of the support structures 5 are placed in a spacer storage 61 of a support structure dispenser 60. The support structures 5 in the storage 61 are provided by deforming a workpiece prior to being placed in the storage 61. This deformation may e.g. be provided as e.g. e.g. described previously.

The dispenser 60 dispenses the support structures 5 from the storage 61 and towards the glass surface 3a. In FIG. 17, the dispenser 60 comprises the storage 61. In other embodiments of the present disclosure, the spacer storage 61 may be separate to a dispenser 60.

The distributing of the support structures 5 comprises dispensing, such as dropping, the support structures 5 individually at the first major surface 3a.

A support structure retainer 64, 63 retains the respective support structure 5 until it is desired to be dispensed/dropped towards the surface 3a. An actuator 70, such as a linear actuator or an electric motor, is controlled so as to dispense the support structures 5.

In the embodiment illustrated in FIG. 17, the retainer comprises a retainer wall 64 provided by a bottom of the dispenser 60. A collection member 63, such as a sheet or the like, is configured to collect a support structure 5 from the storage 61 that is to be dispensed through an outlet 510 in the retainer wall. The collection member 63 and the retainer wall 64 hence retains the support structure 5, and the actuator 70 may move at least one of the collection member 63 and the retainer wall 64 relative to the other. For example, the collection member may be moved relative to the wall 64. The collection member comprises a hole 65 for collecting/holding the support structure to be dispensed. The collection member may receive a support structure from the storage 61 to be dispensed.

The support structure 5 leaves the dispenser 60 through outlet 510 when the hole 65 is opposite to the outlet 510 (this is controlled by means of the actuator 70) and is thereby placed on the glass sheet surface 3a.

As illustrated in a number of the figures described above, see e.g. FIGS. 1a-1c, the deformation unit 20 may, according to embodiments of the present disclosure, comprise pressing bodies 21, 22 comprising a support body 22 and/or press body 21. An actuator 20a, such as a linear actuator, for example an actuator driven by an electric motor, pneumatics and/or the like reduces the distance between pressing surfaces of the pressing bodies 21, 22 so as to shape the workpiece 10.

It is generally understood that according to embodiments of the present disclosure, the material of the support structure workpiece 10, prior to deformation by the deformation unit 20, may extend continuously between the pressing surfaces of the pressing bodies 21, 22 of the deformation unit 20. Hence, the material of the support structure workpiece may substantially provide a continuum between the pressing bodies.

Since the support structure workpiece 10 may be solid, no “artificial” pre-shaped cavities may be provided internally in the support structure workpiece between the pressing surfaces of the pressing bodies 21, 22. The structure of the workpiece 10 material may hence extend continuously between the surface parts of the workpiece 10 that are in contact with/are to be in contact with the respective pressing surface, before initiating the deformation of the workpiece.

It is understood that if the workpieces 10 comprises solid metal balls (see e.g. FIGS. 1a-1c, and 7a) the exterior surface of the solid metal balls may be substantially continuous/uninterrupted and substantially continuously spherical. Hence, no “artificial” predefined openings, such as through holes, may be present in the ball.

### Items

The present disclosure is moreover described in the following items:

1. Method of producing a vacuum insulated glass (VIG) unit (1), wherein said method comprises:
providing a plurality of support structures (5) comprising contact surfaces (5a, 5b),
distributing the provided support structures (5) at a first glass sheet (3) so that one of said contact surfaces (5a, 5b) supports on a first major surface (3a) of the first glass sheet (3),
arranging a second glass sheet (4) so that the distributed support structures (5) are placed in a gap (6) between the first major surface (3a) and a second major surface (4a) of the second glass sheet (4),
providing an edge seal (7) arranged around the periphery of the glass sheets (3, 4), and
evacuating and sealing said gap (6),

wherein the providing of the plurality of support structures comprises the steps of
feeding support structure workpieces (10) to a deformation unit (20), and
shaping support structures (5) by deforming the fed support structure workpieces (10) by means of the deformation unit (20) so as to provide support structures (5) comprising said contact surfaces (5a, 5b).

2. Method according to item 1, wherein the support structure workpieces (10) comprises or consist of substantially spherical balls, such as spherical solid metal balls, such as solid, spherical steel balls.

3. Method according to item 2, wherein the feeding of the spherical balls (10) is provided by means of guiding, such as one or more of pushing, sucking, rolling and/or displacing by means of gravity, the spherical balls (10) from a storage (32) to the deformation unit (20).

4. Method according to item 1, wherein the feeding of the support structure workpieces (10) to the deformation unit (20) comprises separating, such as cutting (35), support structure workpieces (10) from source material (32) such as a filament or wire.

5. Method according to any of the preceding items, wherein the structure of the support structure workpieces (10) is a solid structure, such as a monolithic, solid structure.

6. Method according to any of the preceding items, wherein the deformation of the support structure workpieces (10) by the deformation unit (20) provides support structures (5) comprising two oppositely directed, such as substantially parallel, contact surfaces (5a, 5b) at each support structure (5).

7. Method according to any of the preceding items, wherein the support structure workpieces (10) are made from, such as consist of, a metal such as steel.

8. Method according to any of the preceding items, wherein the support structures (5) are plastically deformed by the deformation unit (20) to have a first support structure height (H1), such as a predetermined first support structure height, that is less than an initial maximum height (H3) of the workpiece (10).

9. Method according to any of the preceding items, wherein the deformation of the support structure workpieces (10) by the deformation unit (20) provides an at least 5% reduction of the initial maximum height (H3) of the support structure workpieces (10) into a first support structure height (H1), such as an at least 20%, such as an at least 40% reduction of the initial maximum height (H3) of the support structure workpieces (10) into a first support structure height (H1).

10. Method according to item 8 or 9, wherein a further, second deformation, such as a plastic deformation, of one or more support structures (5) having the first support structure height (H1) due to the deformation provided by means of the deformation unit (20) is provided by means of the major surfaces (3a, 4a) of the glass sheets facing the gap.

11. Method according to item 10 wherein the further, second deformation provides an at least 10%, such as an at least 20%, for example an at least 30% reduction of the first height (H1) of each support structure (5) of a group, such as a subgroup, of the support structures (5) placed in the gap.

12. Method according to items 8 and 10, wherein the overall deformation provided by means of the deformation unit (20) and by means the further, second deformation of the first support structure height (H1) provides that each support structure (5) of a group, such as a subgroup, of the support structures (5) placed in the evacuated gap (6) has a height (H2) that is least 20% smaller, such as at least 30% smaller, for example at least 40% smaller than the initial maximum height (H3) of the respective workpiece (10).

13. Method according to any of items 10-12, wherein at least 5%, such as at least 10%, such as at least 25% of the total amount of support structures (5) of the vacuum insulated glass unit (1) assembly (50) are subjected to said further, second deformation, such as by means of an evacuation pump (11).

14. Method according to any of the preceding items, wherein the first and/or second glass sheet (3, 4) are tempered glass sheets such as thermally tempered glass sheets.

15. Method according to any of the preceding items, wherein said deformation unit (20) is arranged at a deformation station (230) of a vacuum insulated glass unit assembly (50) manufacturing line (200), wherein the deformation station (20) provides the support structure workpiece (10) deformation during vacuum insulated glass unit assembly (50) manufacturing.

16. Method according to any of the preceding items, wherein said deformation unit (20) is arranged at a deformation station (230) of a vacuum insulated glass unit assembly (50) manufacturing line (200), and wherein the deformation unit (20) provides the support structure workpiece (10) deformation to provide support structures (3) to be placed at a first glass sheet (3) while the first glass sheet (3) is arranged at the vacuum insulated glass unit assembly (50) manufacturing line (200).

17. Method according to any of the preceding items, wherein support structures (5) are placed at the first glass sheet (3) surface (3a) by a support structure placement arrangement of a support structure placement station (240) in a vacuum insulated glass unit assembly (50) manufacturing line,

wherein the deformation unit (20) provides the support structure workpiece (10) deformation to produce support structures (5) to be placed at a first glass sheet (3) after said first glass sheet (3) has been arranged at a support structure placement station (240),

18. Method according to any of the preceding items, wherein the deformation unit (20) provides the support structure work workpiece (10) deformation to produce support structures (5) to be placed at a first glass sheet (3) while the first glass sheet (3) moves through or into a support structure (5) placement station (240).

19. Method according to any of the preceding items, wherein the deformation of the support structure workpieces (10) is provided by consecutively feeding and deforming, such as coining, the support structure workpieces (10) in a continuous feeding and deformation process, preferably during vacuum insulated glass unit assembly (50) manufacturing at a vacuum insulated glass unit assembly (50) manufacturing line.

20. Method according to any of the preceding items, wherein the deformation unit (20) comprises a press (21, 22) such as a mould, such as a press mould (21, 22) and/or a roller press.

21. Method according to any of the preceding items, wherein the weight and/or volume of the respective support structure (5) placed at the first glass sheet substantially corresponds to the weight and/or volume of the support structure workpiece (10) used for the support structure (5) before the deformation by means of the deformation unit (20).

22. Method according to any of the preceding items, wherein said support structures (5) have a first height (H1) that is less than 0.4 mm, such as less than 0.3 mm, for example around or less than 0.2 mm as a result of the deformation by the deformation unit (20).

23. Method according to any of the preceding items, wherein the feeding of the support structure workpieces (10) to the deformation unit (20) is provided by means of a feeding device (40) feeding the support structure workpieces (10) from a support structure workpiece material (10, 31) storage (32).

24. Method according to any of the preceding items, wherein the feeding device (40) comprises a workpiece (10) dosing system (34, 35), such as comprising one or more of
a workpiece material (31) cutter (35),
A supply pipe or tube (36) and/or a slideway (38)
one or more pushing and/or pulling rolls (33)
a removable blocking (34), or
one or more magnets.

25. Method according to any of the preceding items, wherein the workpiece is maintained in position during and/or prior to deformation at the deformation unit by means of one or more of a magnet, one or more side walls (22a) and/or a liquid, such as glycerine.

26. Method according to any of the preceding items, wherein a plurality of said plastically deformed support structures (5) comprises a first convex side surface (5c) and a second opposite, convex side surface (5d) when seen in a cross section of the plastically deformed support structure (5), where said convex side surfaces (5a, 5b) extends between the major glass sheet surfaces (3a, 4a), wherein the convex side surfaces (5c, 5d) each describes minor, circular arcs having non-coinciding centres (C1, C2), such as a result of plastic workpiece (10) deformation by means of the deformation unit (20).

27. Method according to any of the preceding items, wherein the maximum width (W1) of the support structure (5) after the workpiece deformation is larger, such as at least 3% larger, for example 20 % larger, for example at least 30% larger, or at least 100% larger than the initial width (D1) of the workpiece before the workpiece deformation.

28. Method according to any of the preceding items,

wherein the maximum width (W1) of the support structure after the workpiece deformation by the deformation unit (20) is at least 20% larger, such as at least 40% larger, for example at least 50% larger, than the initial width (D1) of the workpiece before the workpiece deformation,

and/or

wherein the maximum width (W1) of the support structure (5) after the workpiece (10) deformation by the deformation unit (20) is between 3% and 120%, such as between 5% and 85%, for example between 20% and 65% larger than the initial width (D1) of the workpiece (10) before the workpiece deformation.

29. Method according to any of the preceding items, wherein said providing of the plurality of support structures comprises that the support structure workpieces (10) are deformed by the deformation unit (20) at a location that is located away from the VIG unit manufacturing line.

30. Method of producing support structures (5) for use in an evacuated gap (6) of vacuum insulated glass units (1), wherein said method comprises the steps of
feeding support structure workpieces (10) to a deformation unit (20), and
shaping support structures (5) by deforming the fed support structure workpieces (10) by means of the deformation unit (20) so as to provide support structures (5) comprising said one or more contact surfaces (5a, 5b),

such as wherein said deformation by means of the deformation unit (20) is provided at a vacuum insulated glass unit assembly (50) manufacturing line (200) prior to arranging the support structures at a glass sheet surface (3a).

31. Method according to item 30, wherein the deformation unit (20) provides the support structure workpiece (10) deformation to provide support structures (3) to be placed at a first glass sheet (3) while the first glass sheet (3) is arranged at the vacuum insulated glass unit assembly (50) manufacturing line (200).

32. Method according to item 30 or 31, wherein the deformation unit (20) provides the support structure workpiece (10) deformation after a first glass sheet (3) comprising a major surface (3a) for receiving and supporting the support structures (5) has been arranged at a support structure placement station (240) of the vacuum insulated glass unit assembly (50) manufacturing line (200).

33. Method according to item 30, 31 or 32, wherein the deformation unit (20) provides the support structure work workpiece (10) deformation to provide support structures (5) to be placed at a first glass sheet (3) comprising a major surface (3a) for receiving the support structures (5) while the first glass sheet (3) moves through or into a support structure (5) placement station (240) of the vacuum insulated glass unit assembly (50) manufacturing line (200).

34. Method of shaping support structures (5) for a vacuum insulated glass unit, wherein said method comprises
providing support structure work pieces (10) to a deformation unit, and
shaping support structures (5) by deforming the provided support structure workpieces (10) by means of a deformation unit (20),

wherein said deformation of the support structure workpieces (10) by means of the deformation unit (20) is provided prior to arranging the support structures (5) at a major surface (3a) of a glass sheet (3) for a vacuum insulated glass unit.

35. Method according to any of items 30-34, wherein the support structure workpieces (10) comprises or consist of substantially spherical balls.

36. Method according to any of items 30-35, wherein the support structure workpieces (10) comprises or consist of substantially spherical solid metal balls, such as solid, spherical steel balls.

37. Method according to any of items 30-36, wherein the structure of the support structure workpieces (10) is a solid structure, such as a monolithic, solid structure, and/or wherein the support structure workpieces (10) are made from, such as consist of, a metal such as steel.

38. Method according to any of items 30-37, wherein the support structure workpieces (10) (5) are plastically deformed by the deformation unit (20) so as to have a predetermined first support structure height (H1), that is less than an initial maximum height (H3) of the workpiece (10), and wherein the height extends between contact surfaces (5a, 5b), of the support structures (5).

39. Method according to any of items 30-38, wherein the deformation unit comprises a press such as a mould, such as a press mould (21, 22) and/or a roller press.

40. Method according to any of items 30-39, wherein the deformation comprises a coining operation.

41. Method according to any of items 30-40, wherein the weight and/or volume of the respective support structure (5) substantially corresponds to the weight and/or volume of the support structure workpiece (10) used for the support structure (5) before the deformation by means of the deformation unit (20).

42. Use of support structures (5) in an evacuated gap (6) of a vacuum insulated glass unit (1), wherein said support structures (5) are provided by deforming support structure workpieces (10), such as spherical balls (10), so as to have a predefined height (H1) by means of a deformation unit (20) prior to arranging the support structures (5) at a surface (3a) of a glass sheet (3) for the vacuum insulated glass unit.

43. Use of support structures (5) according to item 42, wherein the deformation of the support structure workpieces is provided during vacuum insulated glass unit assembly (50) manufacturing at a deformation station (230) of a vacuum insulated glass unit assembly manufacturing line (200).

44. Use of support structures (5) according to item 42 or 43, wherein the support structures (5) are provided and/or shaped by means of a method according to any of the preceding items, such as any of items 1-33 and/or any of items 34-43.

45. A vacuum insulated glass unit comprising a first glass sheet (3) and a second glass sheet (4), and an edge seal arranged around the periphery of the tempered glass sheets, wherein the vacuum insulated glass unit comprises an evacuated gap (6) arranged between major surfaces (3a, 4a) of said first and second glass sheets and wherein the evacuated gap (6) is enclosed by the edge seal, wherein the vacuum insulated glass unit is a vacuum insulated glass unit produced by means of a method according to one or more of the above mentioned items.

46. Use of a deformation unit (20), wherein the deformation unit (20) is used for shaping support structures (5) by deforming support structure workpieces (10) so as to provide support structures comprising contact surfaces (5a, 5b), wherein said deformation unit deforms the support structure workpieces (10) prior to arranging the support structures (5) shaped by the deformation unit (200) at a major surface (3a) of a glass sheet (3) for a vacuum insulated glass unit.

47. Use of a deformation unit according to item 46, wherein said deformation unit comprises a press.

48. Use of a deformation unit according to item 46 or 47, wherein the structure of the support structure workpieces (10) is a solid structure.

49. Use of a deformation unit according to item 46, 47 or 48, wherein said deformation unit deforms the support structure workpieces (10) at vacuum insulated glass unit assembly manufacturing line (200).

50. Use of a deformation unit according to any of items 46-49,wherein the support structure workpieces (10) are plastically deformed by coining by the deformation unit (20) so as to have a first support structure height (H1), such as a predetermined first support structure height (H1), that is less than an initial maximum height (H3) of the workpiece (10).

51. Use of a deformation unit (20) according to any of items 46-50, wherein the deformation unit (20) is located at a vacuum insulated glass unit manufacturing line (200).

52. Use of a deformation unit (20) according to any of items 46-51, wherein the deformation unit is used in a method according to any of the preceding items.

In general, it is to be understood that the present disclosure is not limited to the particular examples described above but may be adapted in a multitude of varieties within the scope of the invention as specified in e.g. the claims and/or items. Accordingly, for example, one or more of the described and/or illustrated embodiments above may be combined to provide further embodiments of the disclosure.

1. Method of producing a vacuum insulated glass unit, wherein said method comprises:
providing a plurality of support structures comprising contact surfaces,
distributing the provided support structures at a first glass sheet so that one of said contact surfaces supports on a first major surface of the first glass sheet,
arranging a second glass sheet so that the distributed support structures are placed in a gap between the first major surface and a second major surface of the second glass sheet,
providing an edge seal arranged around the periphery of the glass sheets, and
evacuating and sealing said gap,
wherein the providing of the plurality of support structures comprises the steps of
feeding support structure workpieces to a deformation unit, and
shaping support structures by deforming the fed support structure workpieces by means of the deformation unit so as to provide support structures comprising said contact surfaces.

2. (canceled)

3. Method according to claim 1, wherein the support structure workpieces comprises substantially spherical solid metal balls.

4.-6. (canceled)

7. Method according to claim 1, wherein the deformation unit comprises a press.

8. (canceled)

9. Method according to claim 1, wherein a plurality of said support structures comprises a first convex side surface and a second opposite, convex side surface when seen in a cross section of the support structure where said convex side surfaces extends between the major glass sheet surfaces, wherein the convex side surfaces each describes minor, circular arcs having non-coinciding centres, plastic workpiece deformation by means of the deformation unit.

10.-12. (canceled)

13. Method according to any of the preceding claims, wherein the support structure workpieces are plastically deformed by the deformation unit so as to have a predetermined first support structure height, that is less than an initial maximum height of the workpiece, and wherein the plastic deformation is provided by coining.

14.-15. (canceled)

16. Method according to claim 1, wherein the deformation of the support structure workpieces by the deformation unit provides an at least 20% reduction of the initial maximum height of the support structure workpieces into a first support structure height.

17. Method according to claim 13, wherein a further, second deformation of one or more support structures having the first support structure height due to the deformation provided by means of the deformation unit is provided by means of the major surfaces of the glass sheets facing the gap, and wherein the further, second deformation is a plastic deformation.

18.-21. (canceled)

22. Method according to claim 1, wherein the maximum width of the support structure after the workpiece deformation by means of the deformation unit is at least 20% larger than the initial width of the workpiece before the workpiece deformation.

23. Method according to any of the preceding claims, wherein the first and/or second glass sheet is/are tempered glass sheets.

24.-25. (canceled)

26. Method according to claim 1, wherein said deformation unit is arranged at a deformation station of a vacuum insulated glass unit assembly manufacturing line, wherein the deformation station provides the support structure workpiece deformation during vacuum insulated glass unit assembly manufacturing.

27. (canceled)

28. Method according to claim 1, wherein the deformation unit comprises a press.

29.-31. (canceled)

32. Method according to claim 1, wherein said support structures have a first height that is less than 0.4 mm a result of the deformation by the deformation unit.

33. (canceled)

34. Method according to claim 1, wherein said distributing of the provided support structures comprises distributing the support structures by means of a support structure dispenser.

35. Method according to claim 34, wherein said dispenser dispenses the support structures from a storage and towards the glass surface.

36. (canceled)

37. Method according to claim 1, wherein a support structure retainer retains the respective support structure until it is desired to be dispensed/dropped towards the surface.

38.-39. (canceled)

40. Method according to claim 39, wherein said balls have a diameter of less than 0.6 mm, and
wherein said balls have a diameter between 0.25 mm and 1.5 mm.

41. Use of support structures in an evacuated gap of a vacuum insulated glass unit, wherein said support structures are provided by plastically deforming support structure workpieces to have a predefined height by means of a deformation unit prior to arranging the support structures at a surface of a glass sheet for the vacuum insulated glass unit.

42. (canceled)

43. Use of support structures according to claim 41, wherein the support structure workpieces comprises substantially spherical, solid metal balls.

44.-47. (canceled)

48. Use of support structures according to claim 41, wherein the support structures are used in a method of producing a vacuum insulated glass unit according to claim 1.

49. A vacuum insulated glass unit comprising a first glass sheet and a second glass sheet, and an edge seal arranged around the periphery of the glass sheets, wherein the vacuum insulated glass unit comprises an evacuated gap arranged between major surfaces of said first and second glass sheets and wherein the evacuated gap is enclosed by the edge seal, wherein the vacuum insulated glass unit is a vacuum insulated glass unit produced by means of a method according to claim 1.
